(19) United States
(12) Patent Application Publication
(10) Pub. No.: US 2016/0361577 A1
(43) Pub. Date: Dec. 15, 2016

(54) INTEGRAL SAFETY HARNESS CONNECTOR ASSEMBLY

(71) Applicant: D B Industries, LLC, Red Wing, MN (US)

(72) Inventors: Judd J. Perner, Red Wing, MN (US); David A. Schlangen, Red Wing, MN (US); Scott C. Casebolt, St. Paul Park, MN (US)

(21) Appl. No.: 14/800,199

(22) Filed: Jul. 15, 2015

Related U.S. Application Data
(60) Provisional application No. 62/173,823, filed on Jun. 10, 2015.

(51) Int. Cl. A62B 35/00

(52) U.S. Cl. CPC A62B 35/0037

(57) ABSTRACT

In one embodiment, a safety harness connector assembly is provided. The safety harness connector assembly includes a D-ring, a device connector system and a shaft. The D-ring is generally a C-shape including a first end portion, a second end portion and mid-portion. The mid-portion extends between the first end portion and the second end portion. The first end portion has a first D-ring aperture and the second end portion having a second D-ring aperture. Moreover, the first D-ring aperture is aligned with the second D-ring aperture. The device connector system includes at least one device connection aperture that is configured and arranged to couple a device to the safety harness connector assembly. The device connector system has at least one shaft connection aperture. A shaft is received in the first and second D-ring apertures of the D-ring and in the at least one shaft connection aperture of the device connector system to pivotally couple the device connector system to the D-ring.

### CROSS-REFERENCE TO RELATED APPLICATIONS

This Application claims priority to U.S. Provisional Application Ser. No. 62/173,823, titled “Safety Harness” herewith, filed on Jun. 10, 2015, which is incorporated in its entirety herein by reference.

### BACKGROUND

Various occupations place people in precarious positions at relatively dangerous heights thereby creating a need for fall-arresting or fall protection safety apparatus. Among other things, such apparatus usually include a safety line interconnected between a support structure and a person working in proximity to the support structure. The safety line is typically secured to a full-body safety harness worn by the worker. A connector may be used to interconnect the safety line and the full-body safety harness as well as provide a connection for other attachments to the safety harness. The connector must be reliable and able to withstand the forces of a fall. In addition, it is preferred that the connector be user friendly.

For the reasons stated above and for other reasons stated below which will become apparent to those skilled in the art upon reading and understanding the present specification, there is a need in the art for an integral safety harness connector that provides an effective and efficient connection point to a safety harness.

### SUMMARY OF INVENTION

The above-mentioned problems of current systems are addressed by embodiments of the present invention and will be understood by reading and studying the following specification. The following summary is made by way of example and not by way of limitation. It is merely provided to aid the reader in understanding some of the aspects of the invention.

In one embodiment, a safety harness connector assembly is provided. The safety harness connector assembly includes a D-ring, a device connector system and a shaft. The D-ring is generally a C-shape including a first end portion, a second end portion and mid-portion. The mid-portion extends between the first end portion and the second end portion. The first end portion has a first D-ring aperture and the second end portion having a second D-ring aperture. Moreover, the first D-ring aperture is aligned with the second D-ring aperture. The device connector system includes at least one device connection aperture that is configured and arranged to couple a device to the safety harness connector assembly. The device connector system has at least one shaft connection aperture. A shaft is received in the first and second D-ring apertures of the D-ring and in the at least one shaft connection aperture of the device connector system to pivotally couple the device connector system to the D-ring.

In another embodiment, another safety harness connector assembly is provided. The safety harness connector assembly includes a D-ring, a shaft and a device connector system. The D-ring has generally a C-shape and includes a first end portion, a second end portion and mid-portion that extends between the first end portion and the second end portion. The first end portion has a first D-ring aperture and the second end portion has a second D-ring aperture. The first D-ring aperture is aligned with the second D-ring aperture. The shaft is received in the first and second D-ring apertures of the D-ring. The device connector system is configured and arranged to couple devices to the safety harness connector assembly. The device connector system includes a base member, a first connector member, a swivel connector and a second connector member. The base member includes at least one shaft connection aperture to receive the shaft therein pivotally coupling the base member to the D-ring. The first connector member is pivotally coupled to the base member. The first connector member has a first device connection passage. The swivel connector is pivotally coupled to the first connector member. The second connector member is pivotally coupled to the swivel connector. The connector member has a second device connection passage.

In further still another, embodiment, another safety harness connector assembly is provided. The safety harness connector assembly includes a device connector system, a base member, a first connector member, a swivel and a second connector member. The device connector system is configured and arranged to couple devices to the safety harness connector assembly. The base member is pivotally coupled to at least one webbing of a safety harness. The first connector member is pivotally coupled to the base member. The first connector member has at least one first device connection passage. The swivel connector is pivotally coupled to the first connector member. The second connector member is pivotally coupled to the swivel connector. The second connector member has at least one second device connection passage.

### BRIEF DESCRIPTION OF THE DRAWINGS

The present invention can be more easily understood and further advantages and uses thereof will be more readily apparent, when considered in view of the detailed description and the following figures in which:

FIG. 1 is a side perspective view of a safety harness connector assembly of one embodiment of the present invention;

FIG. 2 is an exploded side view of the safety harness connector assembly of FIG. 1;

FIG. 3A is a side perspective view of a base dorsal member of one embodiment of the present invention;

FIG. 3B is a front view of the base dorsal member of FIG. 3A;

FIG. 3C is a side view of the base dorsal member of FIG. 3A;

FIG. 3D is a back perspective view of the base dorsal member of FIG. 3A;

FIG. 3E is a lower view of the base dorsal member of FIG. 3A;

FIG. 4A is a first side view of a first connector member of a device connector system of the safety harness connector assembly of FIG. 1;

FIG. 4B is a second side view of a first connector member of a device connector system of the safety harness connector assembly of FIG. 1;

FIG. 5A is a side perspective view of the safety harness connector assembly of FIG. 1 coupled to webbings of a safety harness in one embodiment of the present invention;

FIG. 5B is a back view of the safety harness connector assembly of FIG. 1 coupled to webbings of a safety harness in one embodiment of the present invention;

FIG. 5C is a front view of the safety harness connector assembly of FIG. 1 coupled to webbings of a safety harness in one embodiment of the present invention;

FIG. 5D is a front view of the safety harness connector assembly of FIG. 1 coupled to a safety harness in one embodiment of the present invention;

FIG. 6A is a side perspective view of the device connector system of the safety harness connector assembly of FIG. 1 in a configuration to couple a self retracting lifeline system to safety harness webbings in one embodiment of the present invention;

FIG. 6B is a side perspective view of the device connector system of the safety harness connector assembly of FIG. 1 coupling the self retracting lifeline system of FIG. 6A to the safety harness webbings;

FIG. 7A is a side perspective view of the device connector system of the safety harness connector assembly of FIG. 1 in a configuration to couple a self retracting lifeline system to safety harness webbings with a different SRL connector in one embodiment of the present invention;

FIG. 7B is a side perspective view of the device connector system of the safety harness connector assembly of FIG. 1 coupling the self retracting lifeline system of FIG. 7A to the safety harness webbings;

FIG. 8A is a side perspective view of the device connector system of the safety harness connector assembly of FIG. 1 in a configuration to couple a self retracting lifeline system to safety harness webbings with yet another type of SRL connector in one embodiment of the present invention;

FIG. 8B is a side perspective view of the device connector system of the safety harness connector assembly of FIG. 1 coupling the self retracting lifeline system of FIG. 8A to the safety harness webbings;

FIG. 9A is a side perspective view of a safety harness connector assembly of another embodiment of the present invention;

FIG. 9B is a side perspective view of the safety harness connector assembly of FIG. 9A with its device connector system in a different configuration;

FIG. 10 is an exploded side view of the safety harness connector assembly of FIG. 9A;

FIG. 11 is a back view of the safety harness connector assembly of FIG. 9A coupled to webbings of a safety harness;

FIG. 12 is a side perspective view of the safety harness connector assembly of FIG. 9A with a carabiner attached;

FIG. 13 is a side perspective view of the safety harness connector assembly of FIG. 9A with a SRL system attached;

FIG. 14 is a side perspective view of the safety harness connector assembly of FIG. 9A with a different SRL system attached;

FIG. 15A is a side perspective view of still another safety harness connector assembly of one embodiment of the present invention;

FIG. 15B is a front view of the safety harness connector assembly of FIG. 15A;

FIG. 15C is a back view of the safety harness connector assembly of FIG. 15A;

FIG. 15D is a first side view of the safety harness connector assembly of FIG. 15A;

FIG. 16 is an exploded side view of the safety harness connector assembly of FIG. 15A;

FIG. 17 is a front perspective view of the safety harness connector assembly of FIG. 15A attached to a SRL system.

FIG. 18A is a side perspective view of another safety harness connector assembly of one embodiment of the present invention;

FIG. 18B is a side perspective view of the safety harness connector assembly of FIG. 18A with the device connector system in a different configuration;

FIG. 19 is a back view of the safety harness connector assembly of FIG. 18A;

FIG. 20 is an exploded side perspective view of the safety harness connector assembly of FIG. 18A;

FIG. 21 is a side perspective view of still another safety harness connector assembly of one embodiment of the present invention;

FIG. 22 is a back perspective view of the safety harness connector assembly of FIG. 21A;

FIG. 23 is an exploded side perspective view of the safety harness connector assembly of FIG. 21;

FIG. 24 is a front perspective view of a SRL system coupled to the safety harness connector assembly of FIG. 21;

FIG. 25 is a side perspective view of another SRL system coupled to the safety harness connector assembly of FIG. 21;

FIG. 26A is a side perspective view of a device connector system of the safety harness connector assembly of FIG. 21;

FIG. 26B is a side perspective view of a device connector system of another embodiment of the present invention;

FIG. 26C is a side perspective view of a device connector system of another embodiment of the present invention;

FIG. 27 is a side perspective view of still another safety harness connector assembly of one embodiment of the present invention coupled to harness webbing;

FIG. 28 is a back perspective view of the safety harness connector assembly of FIG. 27;

FIG. 29 is an exploded side perspective view of the safety harness connector assembly of FIG. 27; and

FIG. 30 is a side perspective view of a SRL system coupled to the safety harness connector assembly of FIG. 27.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

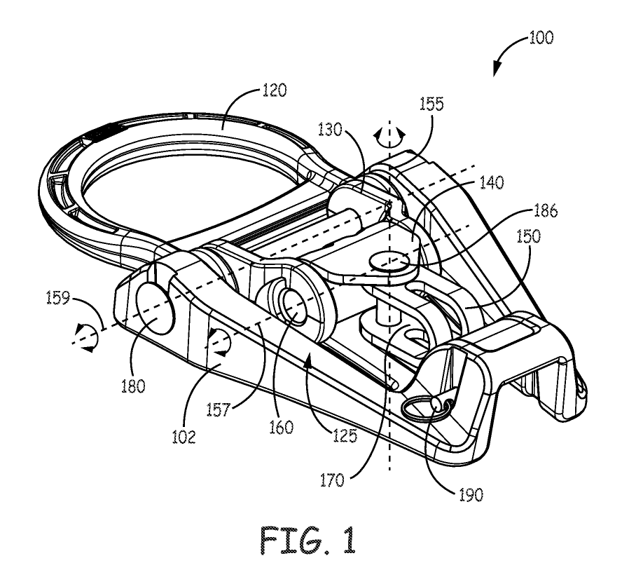

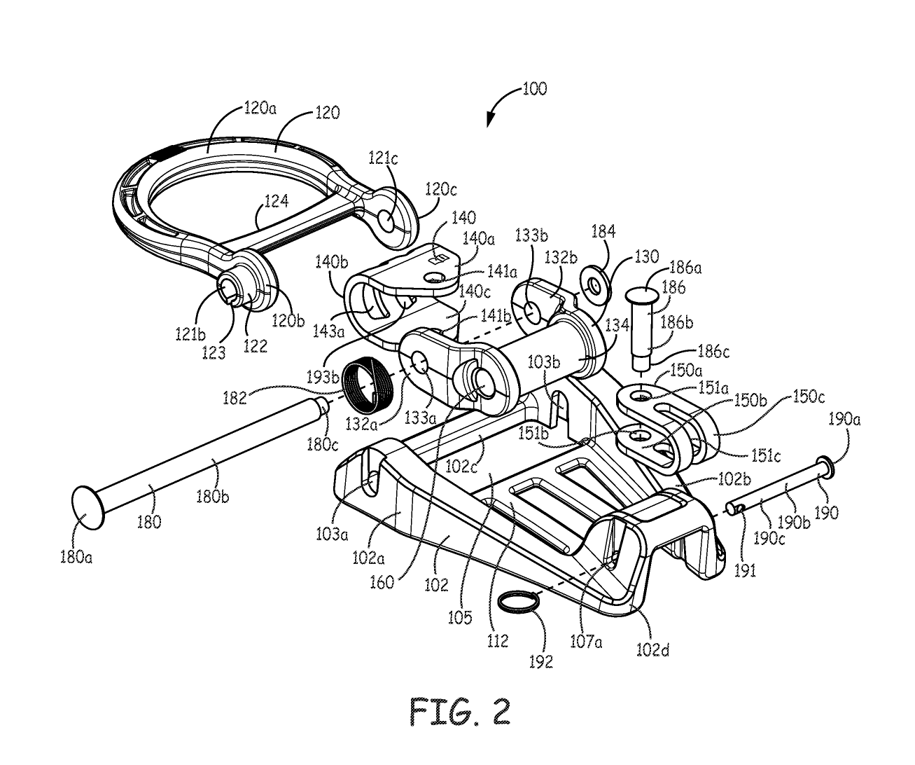

Embodiments of the present invention provide an integral safety harness connector assembly. The safety harness connector assembly can be used to couple any type of device to a safety harness such as, but not limited to, a self retracting lifeline (SRL) system. A first embodiment of the safety harness connector assembly 100 is illustrated in FIG. 1. In this embodiment, the safety harness connector assembly 100 includes a D-ring 120, a base dorsal member 102 a device connector system 125. The elements of the safety harness connector assembly 100 are further described in view of the unassembled view provided in FIG. 2. The D ring 120 is generally C shaped having a mid-portion 120a, a first end portion 120b and a second end portion 120c. A brace 124 extends across the D-ring 120 proximate the first end portion 120b and the second end portion 120c. Each of the first end portion 120b and the second end portion 120c includes a respective D-ring aperture 121b and 121c. The D-ring apertures 121b and 121c are aligned with each other. In the embodiment of the FIG. 2, the first end portion 120b includes an extending sleeve portion 122 that is positioned around the ring aperture 121b. The sleeve portion 122 includes a biasing receiving slot 123. An arm of a biasing member 182 (a torsion spring in this example embodiment) is received within the biasing receiving slot 123 of the sleeve portion 122 to assert a biasing force on the D-ring 120 to position the D-ring 120 to be at a desired position in relation to the base dorsal member 102.

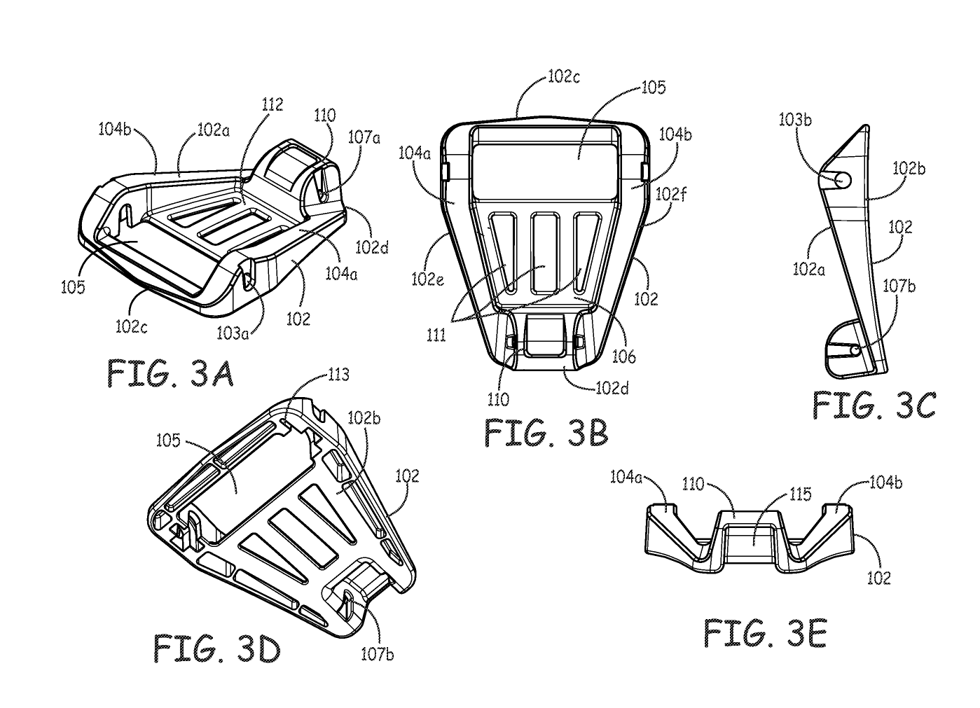

The base dorsal member 102 is further shown in FIGS. 3A through 3E. The base dorsal member 102 includes a front side surface 102a and a back side surface 102b. Further, the base dorsal member 102 includes an upper edge 102c and an opposed lower edge 102d. Moreover, the base dorsal member 102 includes a first side edge 102e and an opposed second side edge 102f as illustrated in FIG. 3B. As illustrated in the Figures, the upper edge 102c has a greater length than the lower edge 102d of the base dorsal member 102. Extending along the length of the first side edge 102e is a first side wall 104a. The first side wall 104a has a height that varies along its length. In the embodiment, the height of the first side wall 104a has a low height at the lower edge 102d. From the lower edge 102d, the height of the first wall 104a increases until the height of the first wall 104a reaches a maximum height at a select location. The select location of the maximum height is near the upper edge 102c. The height of the first wall 104a then decreases from the point of maximum height to the upper edge 102c. The base dorsal member 102 further includes a second side wall 104b that extends along the length of the second side edge 102f. In one embodiment, the second side wall 104b is a mirror image of the first side wall 104a. Positioned between the first and second side walls 104a and 104b is a mid-plate portion 106. The first side wall 104a, the second side wall 104b and the mid-plate portion 106 form a holding tray 112 for elements of the safety harness connection assembly 100. The mid-plate portion 106 includes a plurality of shaped slots 111 in this embodiment. Moreover, in this embodiment, the mid-plate portion 106 only extends a portion of a distance between the lower edge 102d and the upper edge 102c of the base dorsal member 102. A webbing passage 105 is positioned between the mid-plate portion 106 and the upper edge 102c of the base dorsal member 102. Each of the first and second side walls 104a and 104b includes a respective dorsal aperture 103a and 103b. The respective dorsal apertures 103a and 103b are aligned with each other and are positioned in the respective first and second side walls 104a and 104b at a location that is proximate the location of the maximum height of the respective first and second sidewalls 104a and 104b. Moreover, the respective dorsal apertures 103a and 103b are positioned on opposite sides of the webbing passage 105. The base dorsal member 102 further includes a biasing arm holding slot 113 which is illustrated in FIG. 3D. The biasing holding member slot 113 holds an arm of biasing member 182.

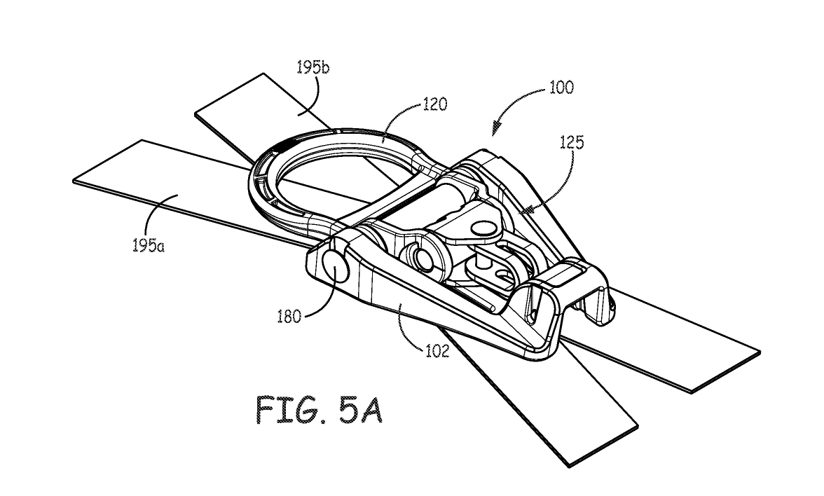

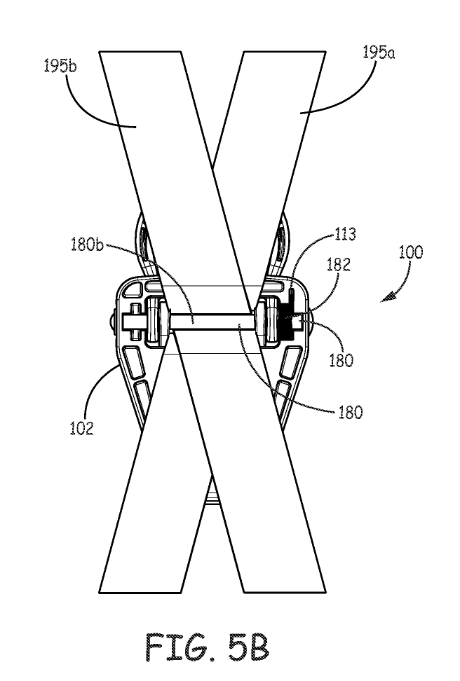

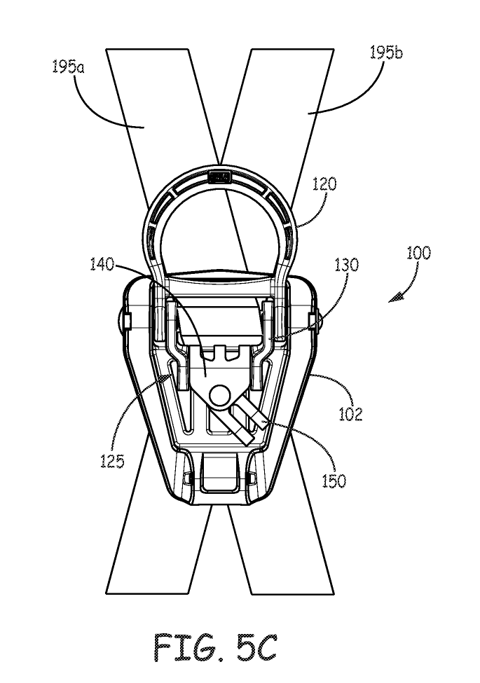

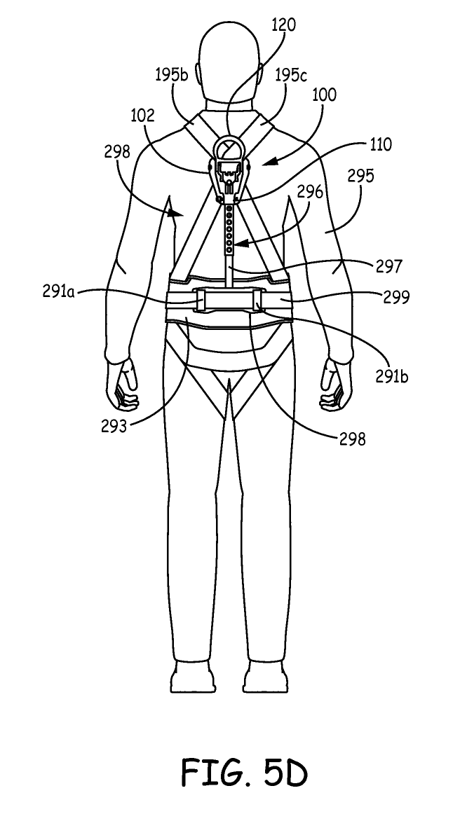

Proximate the lower edge 102d of the base dorsal member 102 in this embodiment is a load attachment member 110. The load attachment member 110 in one embodiment is used to attach a load distribution system 296 of a safety harness 298 (shown generally in FIG. 5D) to the safety harness connection assembly 100. The load attachment member 110 includes a pair of aligned spaced load attachment apertures 107a and 107b and a cavity 115. A clevis pin 190, as illustrated in FIG. 2, passes through the load attachment apertures 107a and 107b to couple a portion the load distribution system 296 of the safety harness 298, received in the cavity, to the safety harness connection assembly 100. The clevis pin 190, in this example embodiment, includes a head 190a, a pin mid-portion 190b and an end portion 190c. In the end portion 190c is a ring aperture 191 that is designed to receive a split ring 192 to lock the clevis pin 190 to the load attachment member 110.

Referring to FIG. 2, the D-ring 120 is coupled to the base dorsal member 102 via dorsal rivet 180. In particular, the dorsal rivet 180 includes a head 180a, a mid-shaft portion 180b and end portion 180c. The end portion 180c of the dorsal rivet 180 has a smaller diameter than the mid-shaft portion 180b in this embodiment. The end portion 180c is connected to connecting nut 184. The mid-shaft portion 180b of the dorsal rivet 180 is received in the dorsal aperture 103a, D-ring aperture 121b, D-ring aperture 121c and dorsal aperture 103b to pivotally couple the D-ring 120 to the base dorsal member 102. The dorsal rivet 180 is also used to attach the safety harness connector assembly 100 to webbing of a safety harness. Referring to FIGS. 5A through 5B illustrations of the harness connector assembly 100 coupled to webbings 195a and 195b that are part of a safety harness system is shown. Webbings 195a and 195b would typically run along a back of a user from the user's shoulders to a belt webbing (not shown). In the embodiment shown, the webbings 195a and 195b cross. The harness connector assembly 100 is coupled at a point where the webbing 195a and 195b cross. In particular, as illustrated in the back view of FIG. 5B, the webbings 195a and 195b are routed around dorsal rivet 180 in the webbing passage 105 of the base dorsal member 102. In one embodiment, the harness connector assembly 100 is mounted on the webbings 195a and 195b by first placing the crossing webbings 195a and 195b in the webbing passage 105 of the base dorsal member 102 and then inserting the dorsal rivet 180 through dorsal apertures 103a and 103b of the base dorsal member 102. In addition, as illustrated in FIG. 5B the biasing member 182 is positioned around the dorsal rivet 180 with one of its arms received in the biasing holding member slot 113 of the base dorsal member 102. As discussed above, another arm of the biasing member 182 is received within the biasing receiving slot 123 of the sleeve portion 122 to assert a biasing force on the D-ring 120 to cause the D-ring to be at a desired position in relation to the base dorsal member 102.

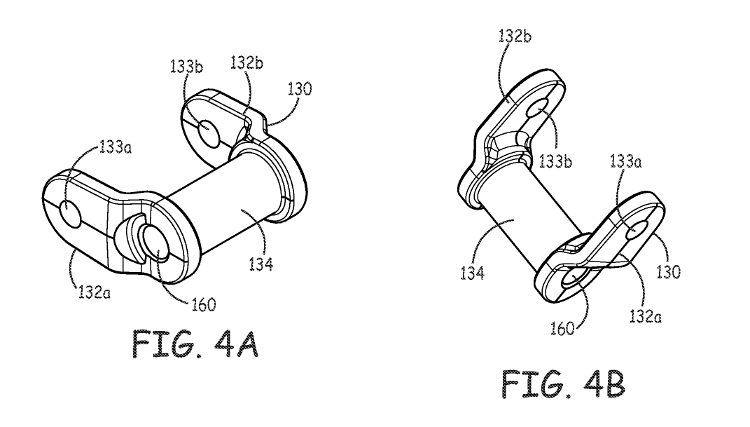

The device connector system 125 includes a first connector member 130, a swivel connector 140 and a second connector member 150. The first connector member 130 is shown in detail in FIGS. 4A and 4B. The first connector member 130 includes a first arm 132a and a second arm 132b that extend out on opposite ends of a mounting rod 134. The mounting rod 134 includes a central mounting passage 160 that passes though the entire length of the mounting rod 134. Each of the first arm and the second arm 132a and 132b includes a respective rivet passage 133a and 133b. The respective rivet passages 133a and 133b are positioned proximate terminal ends of each respective arm 132a and 132b. Moreover the rivet passages 133a and 133b are aligned. The first connector member 130 is pivotally coupled to the base dorsal member 102 via the dorsal rivet 180 received in the aligned rivet passages 133a and 133b of the first connector member 130. Referring back to FIG. 2, the swivel connector 140 of the device connector system 125 is further described. The swivel connector 140 is generally C-shaped having a swivel first end 140a, a swivel second end 140c and a curved swivel mid-portion 140b. The swivel mid-portion 140b has a width that is generally equal to the width of the mounting rod 134 of the first connector member 130. Moreover, the curve of the swivel mid-portion 140b of the swivel connector 140 matches generally the radius of curvature of the mounting rod 134 of the first connector member 130. The swivel mid-portion 140b of the swivel connector 140, in this embodiment, includes slots 143a and 143b. Moreover, swivel mid-portion 140b of the swivel connector 140 is positioned around the mounting rod 134 of the first connector member 130. Each of the respective swivel first and second ends 140a and 140c of the swivel connector 140 generally taper to a terminal point. Moreover, each of the swivel first and second ends 140a and 140c of the swivel connector 140 include pivot connection apertures 141a and 141b. The pivot connection apertures 141a and 141b of the swivel connector 140 are aligned with each other.

As further illustrated in FIG. 2, the second connector member 150 is also generally C-shaped. The second connector member 150 has a first end portion 150a, a second end portion 150b and a curved mid-portion 150c. The first and second end portions 150a and 150b terminate in a rounded configuration. The curved mid-portion 150c, in this embodiment, includes a slot 151c. Each of the first end portion 150a and the second end portion 150b include a respective first and second connector aperture 151a and 151b.

The device connector system 125 is coupled to the base dorsal member 102 of the safety harness connector assembly 100 via dorsal rivet 180 received in the rivet passages 133a and 133b of the first connector member 130. In the example embodiment shown in FIG. 2, a connector washer 184 is received on the end portion 180c of the dorsal rivet 180. Washer 184 is used to provide a surface for a rivet heading operation. The washer 184 further sets the effective length of the rivet by compressing against a rivet shoulder. The swivel mid-portion 140b of the swivel connector 140 is received around the mounting rod 134 of the first connector member 130. A connector rivet 186 that includes a head 186a, a terminal end portion 186c and a mid-shaft portion 186b couples the swivel connector 140 to the first connector member 130. As illustrated in FIG. 2, the terminal end portion 186c of the connector rivet 186 has a smaller diameter than the mid-shaft portion 186b in this example embodiment. The connector rivet 186 received in the pivot connection aperture 141a and 141b of the swivel connector 140 pivotally couples the swivel connector 140 to the first connector member 130. The swivel connector 140 pivotally rotates about the mounting rod 134 of the first connector member 130. The connector rivet 186 further pivotally couples the second connector member 150 to the swivel connector 140. In particular, the connector rivet 186 is received in the first and second connector apertures 151a and 151b of the second connecter member 150 to pivotally couple the connector member 150 to the swivel connector 140. The pivot connections between each of the first connector member 130 and the base dorsal member 102, the first connector member 130 and the swivel connector 140 and the swivel connector 140 and the second connector member 150 allow the device connector 125 to be positioned in different configurations for attachment of different types of devices. In FIG. 1, the device connector system 125 is shown being positioned in the holding tray 112 of the base dorsal member 102. Moreover, FIG. 5C illustrates the second connection member 150 being pivoted in relation to the swivel connector 140. In addition, in the example embodiment as illustrated in FIG. 1, a pivot axis 155 of the second connector member 150 about connector rivet 186 is generally in a perpendicular orientation in relation to a pivot axis 157 of the swivel connector 140 about the mounting rod 134 and a pivot axis 159 of the first connector member 130 about dorsal rivet 180. In addition, FIG. 5D illustrates the safety harness connector assembly 100 coupled to a safety harness 298 donned by a user 295. In particular, the safety harness connector assembly 100 is coupled to webbings 195a and 195b of the safety harness 298. Also illustrated in FIG. 5D is a load distribution system 296 that is coupled to the load attachment member 110 of the safety harness connector member 130. The load distribution system 297 transfers a load on the safety harness connector assembly 100 via an adjustable load bar 297 to a hip plate 298 that is coupled to a hip pad 293 of the safety harness 298. As further illustrated, a hip webbing 299 of the safety harness 298 is routed through webbing holding members 291a and 291b in the hip plate 298.

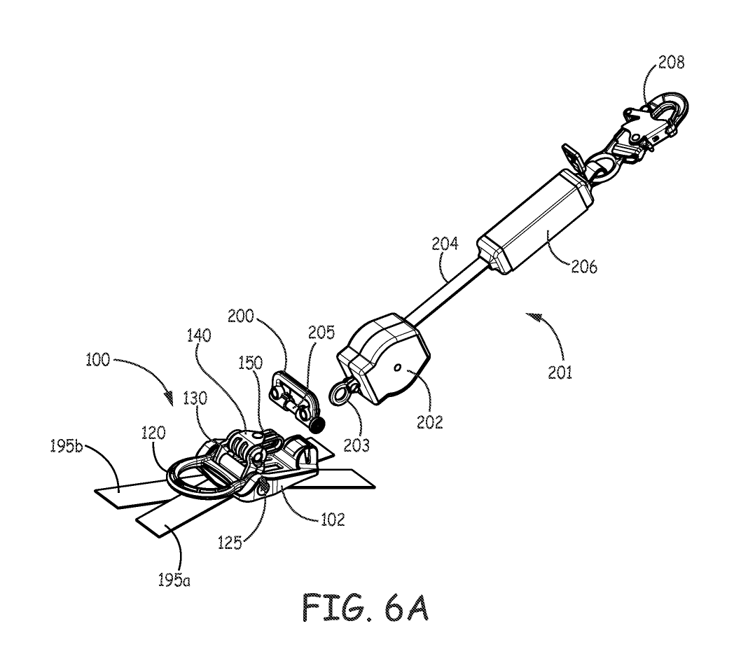

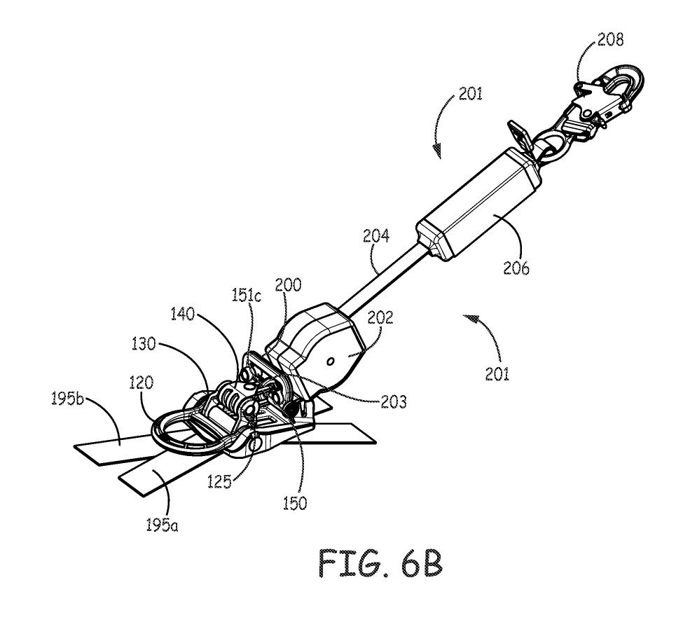

Referring to FIG. 6A an illustration of the device connector system 125 positioned in a configuration to receive a device connector 200 is shown. In this example, the connector 200 is a self retracting lifeline (SRL) connector. FIG. 6A further illustrates a SRL system 201 that includes a SRL 202, a lifeline 204, an energy absorbing system 206 and a support structure connector 208. A connecting ring 203 is coupled to a housing of the SRL 202. FIG. 6B illustrates the SRL system 201 coupled to the safety harness connector assembly 100. In this example, the connecting ring 203 receives a mounting rod portion 205 of the SRL connector 200. The mounting rod portion 205 is also received within the second connection passage 170 of the second connection member 150 to pivotally couple the SRL system 201 to the webbing 195a and 195b of a safety harness. FIG. 6B further illustrates that in this configuration, the connecting ring 203 is received in the slot 151c of the second connection member 150.

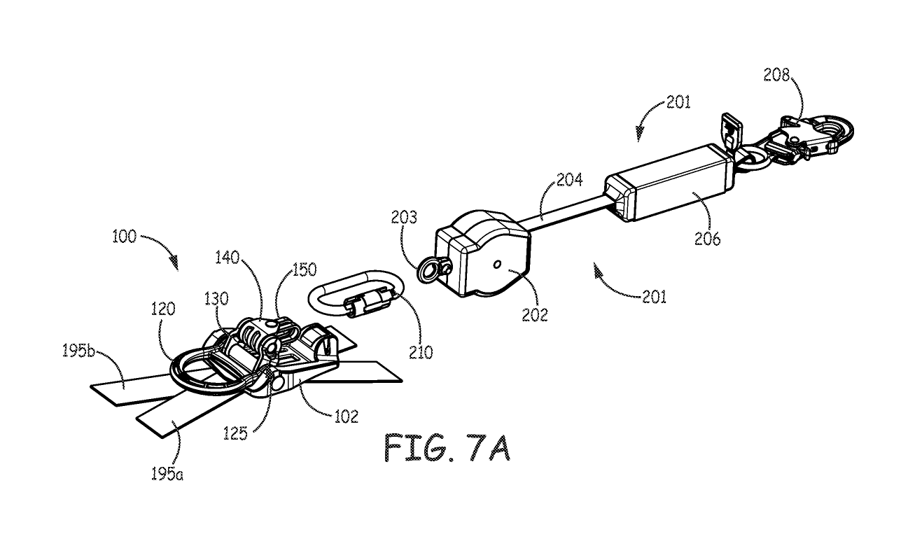

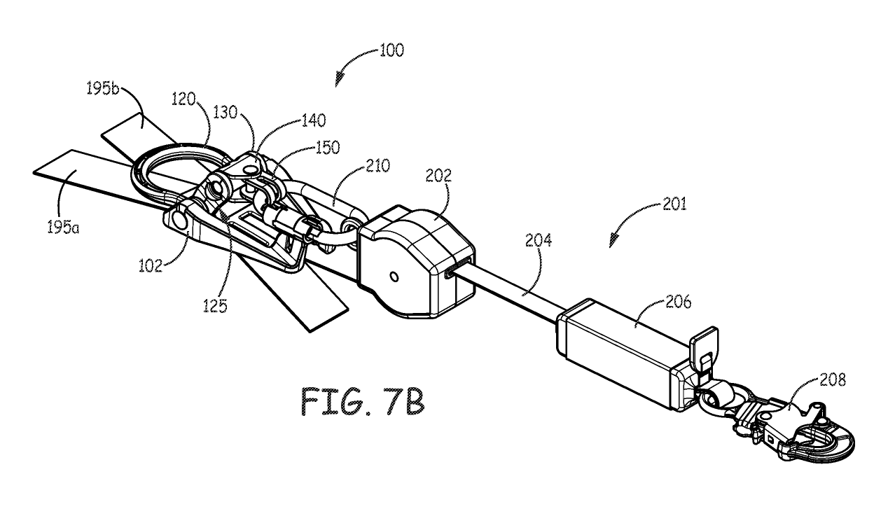

FIG. 7A is an illustration of the device connector system 125 positioned in a configuration to receive a different SRL connector 210. In this example, the SRL connector 210 is a carabiner. FIG. 6B illustrates the SRL system 201 coupled to the safety harness connector assembly 100 via carabiner connector 210. In this example, the connecting ring 203 receives a portion of the carabiner connector 210 while another portion of the carabiner connector 210 is received within the second connection passage 170 of the second connection member 150 to pivotally couple the SRL system 201 to the webbing 195a and 195b of a safety harness.

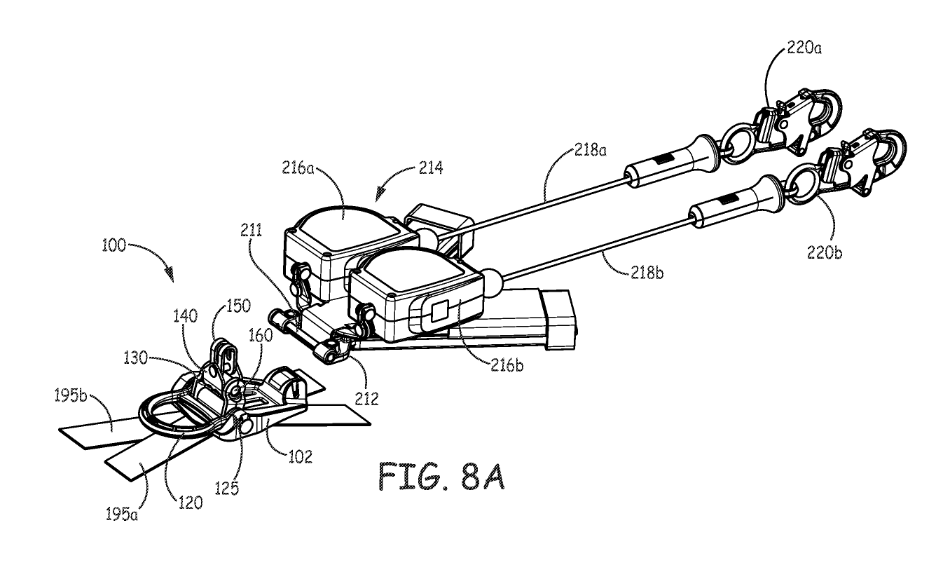

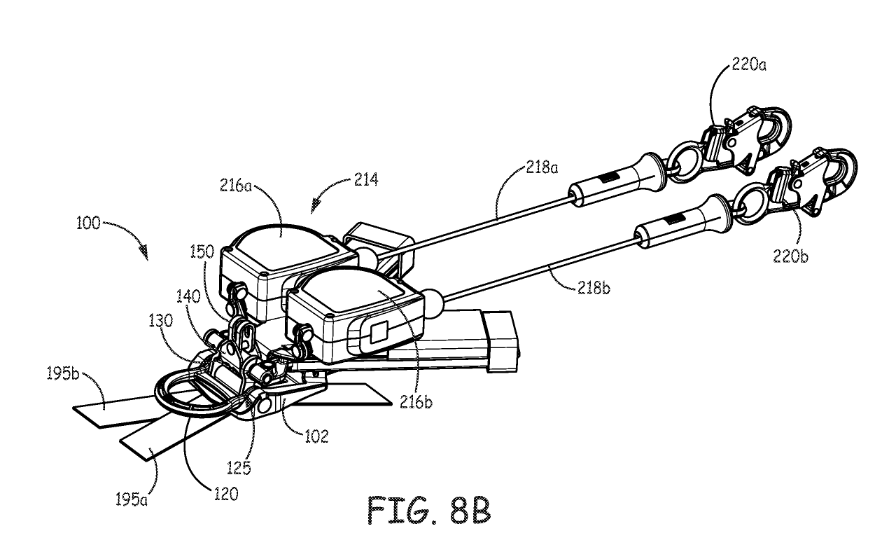

Referring to FIG. 8A, an illustration of the device connector system 125 positioned in a configuration to receive a connector 212 is shown. In this example, the connector 212 is a SRL connector that is designed to attach a dual SRL system 214 to the safety harness connection assembly 100. FIG. 8A illustrates the dual SRL system 214 includes a pair of SRLs 216a and 216b, lifelines 218a and 218b and a support structure connectors 220a and 220b. FIG. 8B illustrates the dual SRL system 214 coupled to the safety harness connector assembly 100. In this example, a mounting rod portion 211 (illustrated in FIG. 8A) of SRL connector 212 is received within the first connector passage 160 of the first connector member 130 to pivotally couple the dual SRL system 214 to the webbing 195a and 195b of a safety harness. Hence, as illustrated and described, the device connector system 125 of the safety harness connector assembly 100 can be positioned in different configurations and has different connection points to enable the device connector system 125 to couple different type of devices and connectors to the webbings 195a and 195b of the safety harness.

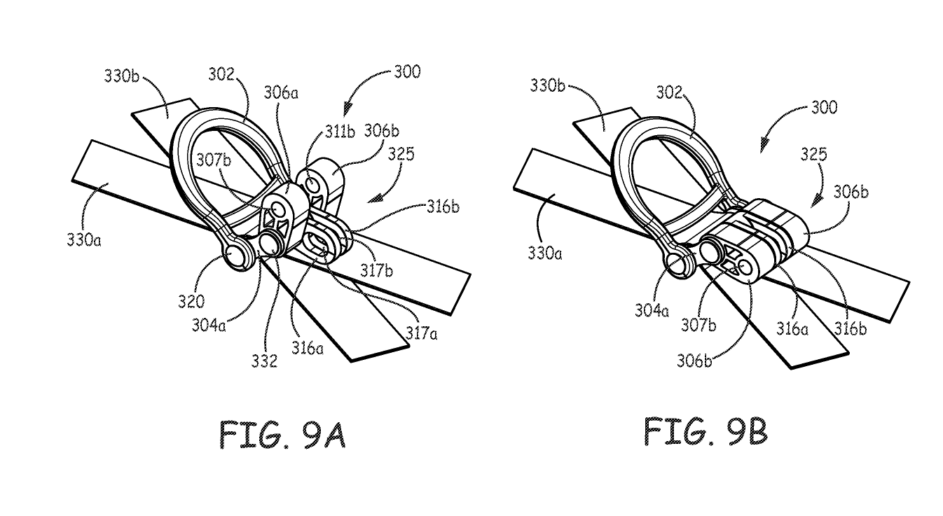

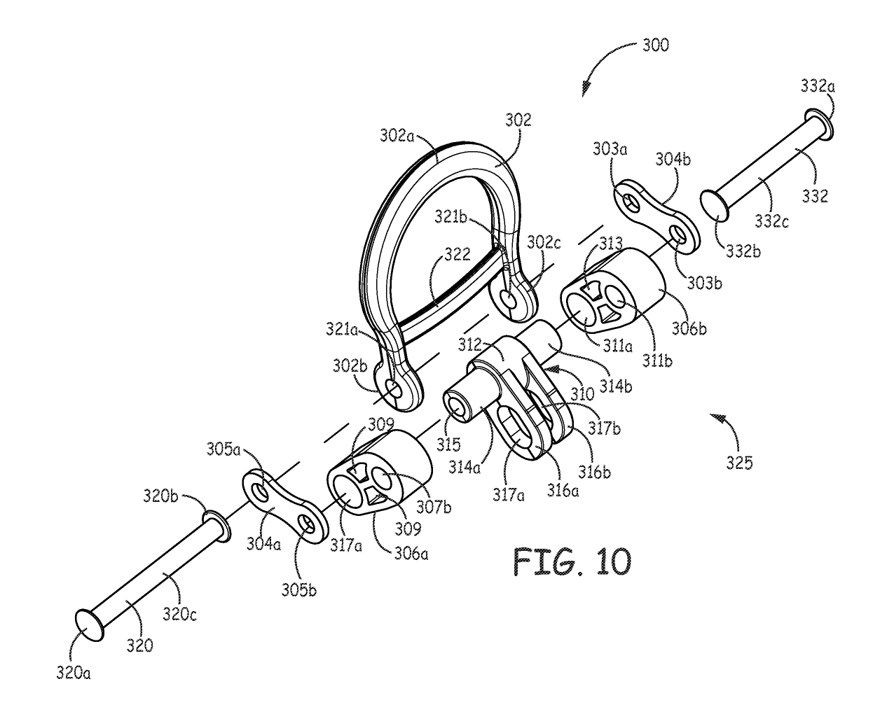

Another embodiment of a safety harness connector assembly 300 is illustrated in FIGS. 9A through 14. FIG. 9A and 9B illustrate the device connector system 325 of the safety harness connection assembly 300 in different configurations to couple different devices to the webbings 330a and 330b of a safety harness (not shown). FIG. 10 illustrates an unassembled view of the safety harness connection assembly 300. The safety harness connection assembly 300 includes a D-ring 302. The D-ring 302 is generally C-shaped having a mid-portion 302a, a first end portion 302b and a second end portion 302c. A brace 322 extends across the D-ring 302 proximate the first end portion 302b and the second end portion 302c. Each of the first end portion 302b and the second end portion 302c includes a respective D-ring aperture 321a and 321b. The D-ring apertures 321a and 321b are aligned with each other.

The safety harness connector assembly 300 further includes a device connector system 325. The device connector system 325 includes a base member 310, a first connector member 306a, a second connector member 306b, a first link 304a, a second link 304b, dorsal rivet 320 and connection rivet 332. The base member 310 includes a mid-barrel portion 312. Extending on opposite ends of the mid-barrel portion 312 are respective first and second tube portions 314a and 314b. The first and second tube portions 314a and 314b have a smaller diameter than a diameter of the mid-barrel portion 312. A central connector rivet aperture 315 extends through the first tube portion 314a, the mid-barrel portion 312 and the second tube portion 314b. The base member further include first and second connecting arms 316a and 316b that extend from a surface of the mid-barrel portion 312 in a spaced parallel fashion. The first and second connecting arms 316a and 316b terminate in rounded edges and each connecting arm 316a and 316b include a respective device connection passage 317a and 317b that are aligned with each other. In the example embodiment, the first connector member 306a is a mirror image of the second connector member 306b. The first and second connector members 306a and 306b extend a select length terminating in rounded edges. The first connector member 306a includes a first aperture 307a that is configured to receive the first tube portion 314a of the base member 310. Similarly, the second connector member 306b includes a first aperture 311a that is configured to receive the second tube portion 314b of the base member 310. The first connector member 306a further includes a connection aperture 307b and the second connector member 306b further includes a connection aperture 311b. In the example embodiment, the first connector member 306a and the second connector member 306b includes respective voids 309 and 313 for reduction of weight purposes. The device connector system 325 further includes a first link 304a and a second link 304b. The first link 304a is a mirror image of the second link 304b. The first and second links 304a and 304b both extend a select length terminating in rounded edges. The first link 304a has a first link first aperture 305a near a first end of the first link 304a and a first link second aperture 305b near a second end of the first link 304a. The second link 304b has a second link first aperture 303a near a first end of the second link 304b and a second link second aperture 303b near a second end of the second link 304b.

A dorsal rivet 320 having a mid-shaft portion 320c and ends that terminate in a first head 320a and a second head 320b is received in the first link first aperture 305a of the first link 304a, in the D-ring apertures 321a and 321b of the D-ring 302 and in the second link first aperture 303a of the second link 304b to pivotally couple the first and second links 304a and 304b to the D-ring 302. A connection rivet 332 having a mid-shaft portion 332c and ends that terminate in a first head 332a and a second head 332b is received in first link second aperture 305b of the first link 304a, the first aperture 307a of the first connector member 306a, the central connector rivet aperture 315 of the base member 310, the first aperture 311a of the second connector member 306b and the second link second aperture 303b of the second link 304b to pivotally couple the remaining portion of the device connector system 325 to the D-ring 302. The pivot connections in this configuration allow for different positioning of the device connector system 325. For example, FIG. 9A illustrates one possible configuration of the device connector system 325 with the connection aperture 307b of the first connector member 306a being aligned with the connection aperture 311b of the second connector member 306b while device connection passages 317a and 317b of the respective first and second connecting arms 316a and 316b are aligned with each other. In the configuration of FIG. 9B all the apertures 307b, 311b and passages 317a and 317b are aligned.

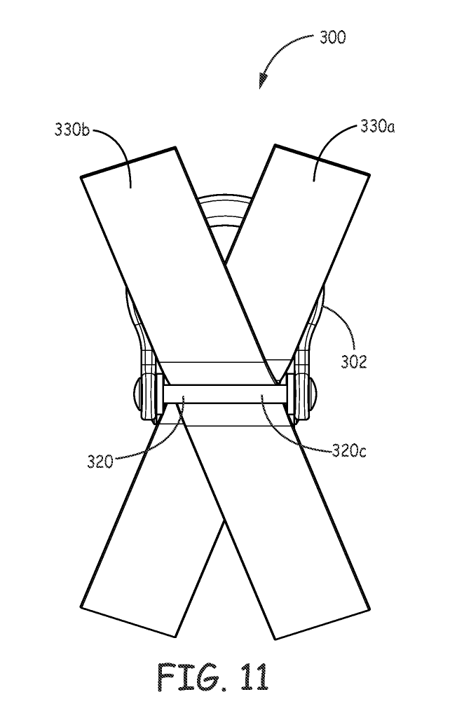

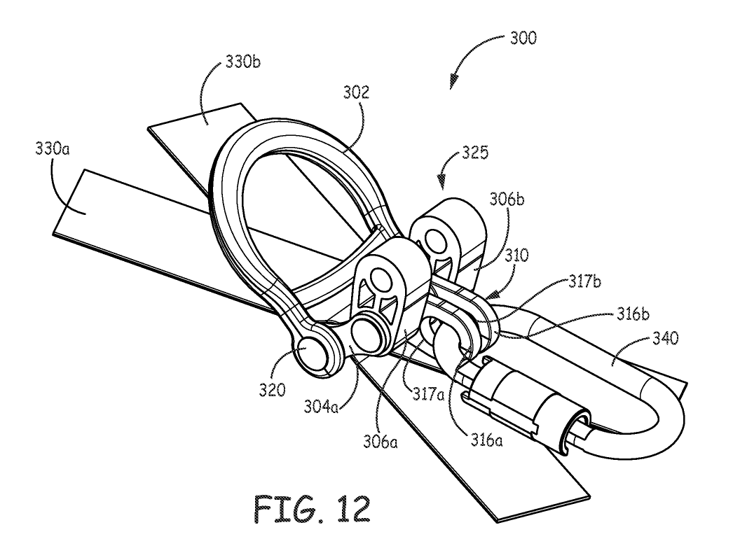

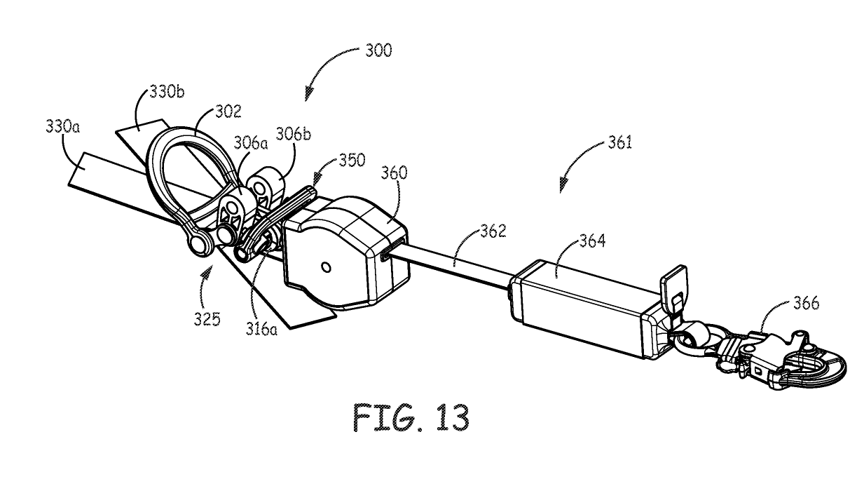

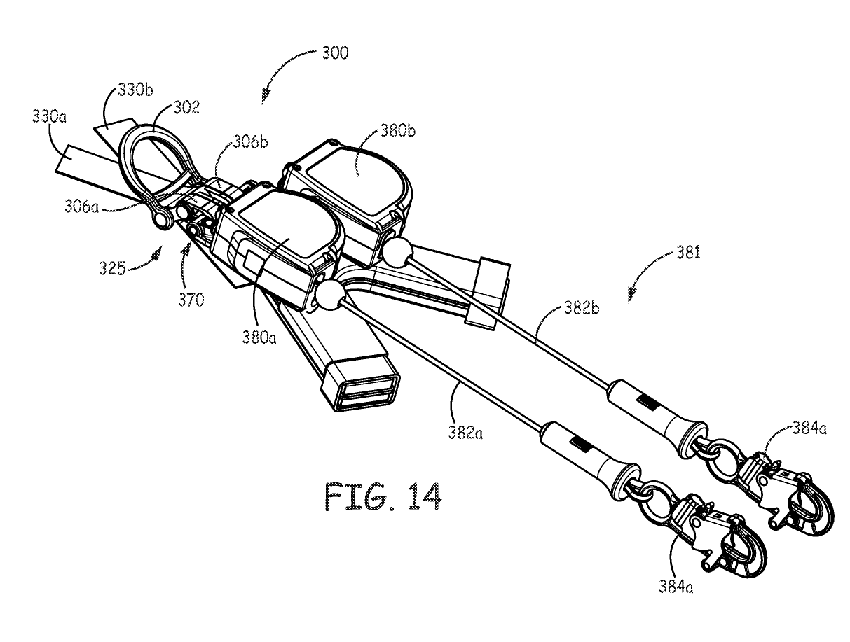

FIG. 11 illustrates the webbings 330a and 330b at their crossing are positioned between the mid-shaft portion 320c of the dorsal rivet 320 and the D-ring 302 and the device connector system 325 used to couple the webbings 330a and 330b of the safety harness to the safety harness connection assembly 300. FIG. 12 illustrates a carabiner 340 being coupled to the device connector system 325 via receiving the carabiner in the device connection passages 317a and 317b of the respective first and second connecting arms 316a and 316b. Any type of device could then in turn be coupled to the carabiner 340. FIG. 13 illustrates a SRL system 361 coupled to webbing 330a and 330b via the device connector system 325. A SRL connector 350 is received in the device connection passages 317a and 317b of the respective first and second connecting arms 316a and 316b of the device connector system 325. The SRL system 361 in this example includes a SRL 360, lifeline 362, energy absorber 364 and a support structure connector 366. Referring to FIG. 14, an illustration of the device connector system 325 coupling a dual SRL system 381 to the webbings 330a and 330b of a safety harness is shown. In this example embodiment, a SRL connector is received in all the aligned apertures 307b, 311b and passages 317a and 317b in the respective first and second connector members 306a and 306b and first and second connecting arms 316a and 316b. The SRL system 381 includes a pair of SRLs 380a and 380b and their respective life lines 382a and 382b and support structure connectors 384a and 384b.

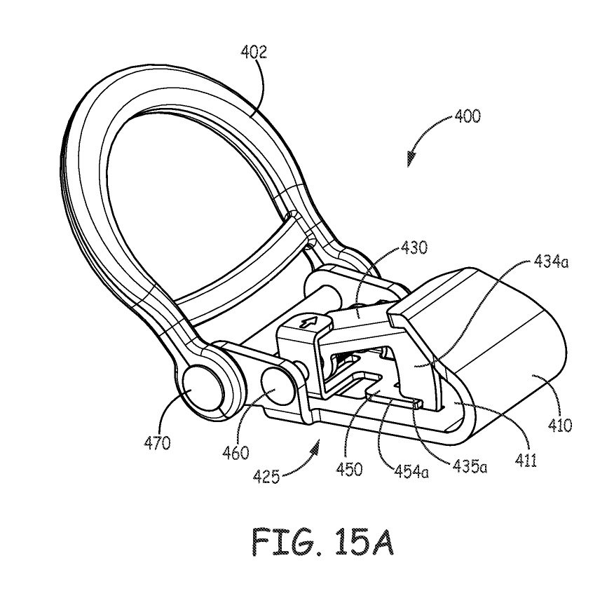

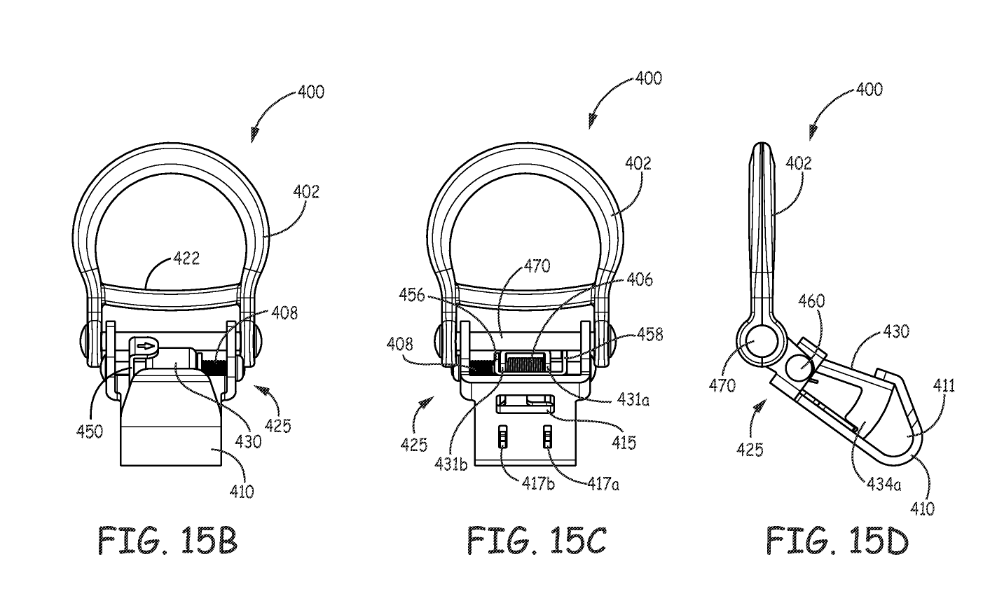

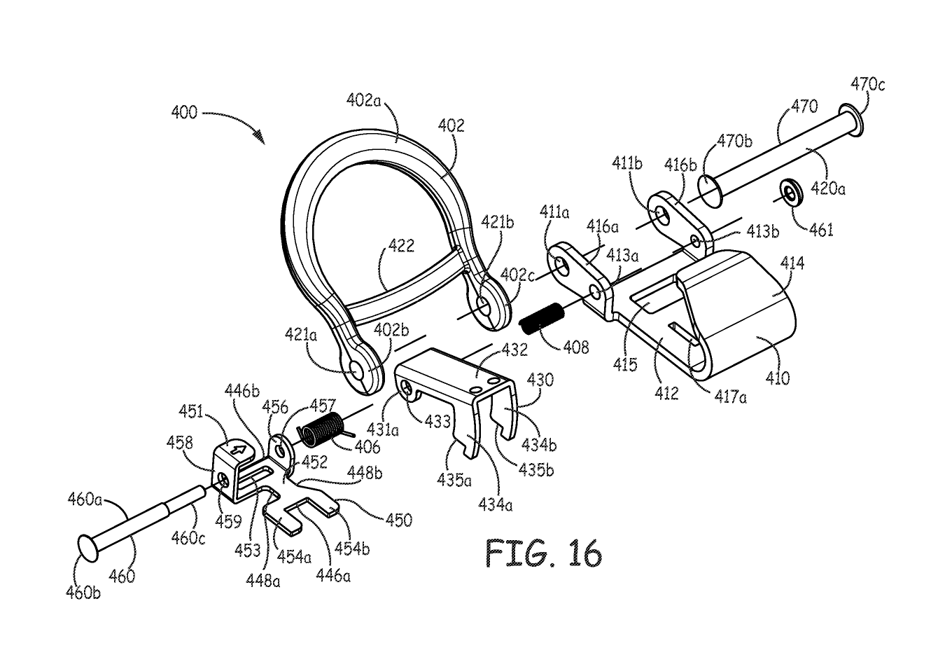

Another embodiment of a safety harness connection assembly 400 is illustrated in FIGS. 15A through 17. This embodiment includes a D-ring 402 and a device connector system 425. As illustrated in the exploded view in FIG. 16, the D-ring 402 is generally C shaped having a mid-portion 402a, a first end portion 402b and a second end portion 402c. A brace 422 extends across the D-ring 402 proximate the first end portion 402b and the second end portion 402c. Each of the first end portion 402b and the second end portion 402c includes a respective D-ring aperture 421a and 421b. The D-ring apertures 421a and 421b are aligned with each other.

The device connector system 425 of the safety harness connection assembly 400 includes a base member 410, a gate member 430 and a lock member 450. The base member 410 includes a base plate 412. At one end of the base plate 412 a stop plate 414 extends. The stop plate 414 is shaped to bend over a portion of the base plate 412. Proximate an opposite end of the base plate 412 extends out a pair of base arms 416a and 416b. Each base arm 416a and 416b extends generally in a perpendicular fashion in relation to the base plate 412. The base arms 416a and 416b are spaced in a parallel fashion in relation to each other generally by a width of the base plate 412. The first base arm 416a includes a first base arm first aperture 411a and a spaced first arm second aperture 413a. The second base arm 416b includes a second base arm first aperture 411b and a spaced second arm second aperture 413b. The first base arm first aperture 411a is aligned with the second base arm first aperture 411b and the first base arm second aperture 413a is aligned with the second base arm second aperture 413b.

The gate 430 includes a gate base plate 432. Extending from opposite sides of the gate base plate 432 proximate a first end of the gate base plate 432 are parallel first and second gate arms 434a and 434b. Portions of the ends of the gate arms 434a and 434b terminate in respective stop edges 435a and 435b. Moreover, extending from opposite sides of the gate base plate 432 proximate a second end of the gate base plate 432 are parallel first and second connecting tabs 431a and 431b. Although only connecting tab 431a is shown in FIG. 16, the opposite connecting tab 431b (shown in FIG. 15C) is a mirror image of connecting tab 431b. Each connecting tab 431a and 431b includes a pivot connection aperture 433. The first and second gate arms 434a and 434b and the connecting tabs 431 extend generally in the same direction in a perpendicular fashion in relation to the gate base plate 432. The lock member 450 includes a lock plate 452. The lock plate 452 includes a first edge 446a and an opposed second edge 446b. The lock plate 452 further includes a third edge 448a and an opposed fourth edge 448b. The lock plate 452 includes a pair of spaced parallel first and second lock stop arms 454a and 454b that generally extend from the first edge 446a of the lock plate 452. The lock plate 452 further includes a first connecting tab 456. The first connecting tab 456 generally extends perpendicular from the lock plate 452 from the fourth edge 448b proximate the second edge 446b. The first connecting tab 456 includes a first lock plate aperture 457. A second connecting tab 458 generally extends perpendicular from the lock plate 452 from the third edge 448a proximate the second edge 446b. The second connecting tab 458 having a second lock plate aperture 459 that is aligned with the first lock plate aperture 457 of the first connecting tab 456. Extending generally perpendicular from the second connecting tab 458 is a third tab 451 in such a manner that the third tab 451 is positioned over and parallel with the lock plate 452. The third tab includes indicium that conveys the direction to move the lock plate 452 to unlock the gate 430. The lock plate 452 in this example embodiment includes a lock slot 453 that extends a select distance between the first connecting tab 456 and the second connecting tab 458.

The device connector system 425 of the safety harness connector assembly 400 further includes a lock biasing member 408, a gate biasing member 406, a dorsal rivet 470 and connection rivet 460. The dorsal rivet 470 includes a mid-portion 470a and ends that terminate in heads 470b and 470c. The connection rivet 460 includes a mid-portion 460a, a head 460b and a connecting end 460c. The connecting end 460c has a diameter that is less than the diameter of the mid-portion 460a. A connection nut 461 engages the connecting end 460c of the connection rivet 460. The base arms 416a and 416b of the base member 410 of the device connector system 425 is positioned between the first and second ends 402b and 402c of the D-ring such that the D-ring apertures 421a and 421b are aligned with the first base arm first aperture 411a and the second base arm first aperture 411b of the base member 410. The dorsal connection rivet 470 is received in the D-ring apertures 421a and 421b and first base arm first aperture 411a and the second base arm first aperture 411b to pivotally couple the base member 410 of the device connector system 425 to the D-ring 402. The lock member 450 and gate member 430 are positioned between the base arms 416a and 416b of the base member 410 such that first base arm second aperture 413b and the second arm second aperture 413b of the base member 410 are aligned with the second lock plate aperture 459 and the first lock plate aperture 457 of the lock member 450 and the gate apertures 433 of the gate 430. The connector rivet 470 is received in the first base arm second aperture 413a and the second arm second aperture 413b of the base member 410 and the second lock plate aperture 459 and the first lock plate aperture 457 of the lock member 450 and the gate apertures 433 of the gate 430 to pivotally couple the gate member 430 to the base member 410. The gate arms 434a and 434b of the gate member 430 are further aligned with gate passages 417a and 417b in the base member 410.

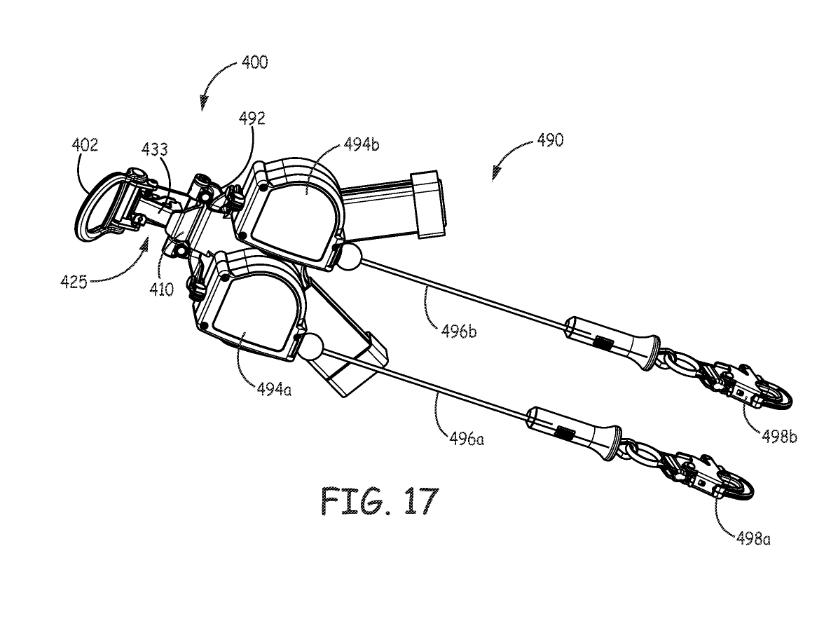

Gate biasing member 406 receives the mid-portion of the connector rivet 470 and is positioned between the connecting tabs 431a and 431b of the gate 430 (as shown in FIG. 15C). The gate biasing member 406 is positioned to bias the gate 430 against the stop plate 414 of the base member 410. The lock biasing member 408 also receives the mid-portion 460a of the connector rivet 460. The lock biasing member 408 is positioned between the second base arm 416b of the base member 410 and the first connecting tab 456 of the lock member 450. The lock biasing member 408 is positioned to bias the lock member 450 into a position that locks the gate 430 in a static configuration in relation to the base member 410. The lock member 450 biased in a lock position is illustrated in FIG. 15A. As illustrated in FIG. 15A, the first lock stop arm 454a of the lock member 450 engages the stop edge 435a of gate arm 434a to prevent the gate arm 434a from traveling into the gate passage 417a of plate 412 of the base member 410. In the locked configuration, a connector can be held within passage 411 (illustrated in FIG. 15D) of the safety harness connector assembly 400. The gate 430 is opened by asserting a force on the lock member 450 to counter the bias force of the lock bias member 408. This action moves the first and second lock stop arms 454a and 454b of the lock member 450 away from the gate passages 417a and 417b of the base member 410. The gate 430 can then be depressed to counter the gate biasing member 406 since the gate arms 434a and 434b can now pass into the gate passages 417a and 417b of the base member 410. When the gate is opened a device connector can be placed in passage 411 of the safety harness connector assembly 400. Once the force is removed from the gate 430, the safety harness connector assembly 400 will once again become locked automatically due to the biasing forces of the gate biasing member 406 and the lock biasing member 408. FIG. 17 illustrates the safety harness connector assembly 400 coupled to an SRL system 490 via SRL connector 492. SRL connector 492 has a portion received within passage 411 of the device connector system 425 of the safety harness connector assembly 400. The SRL system 490 in this example embodiment includes a pair of SRLs 494a and 494b, a pair of lifelines 496a and 496b and a pair of support structure connectors 498a and 498b.

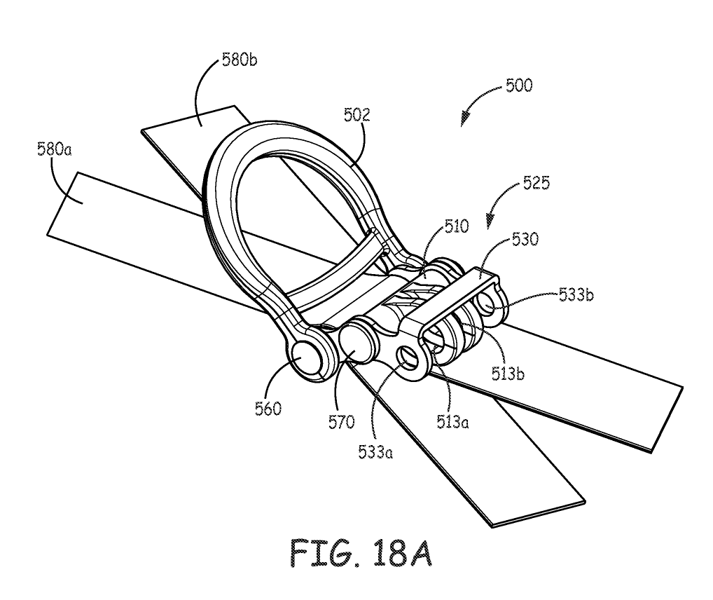

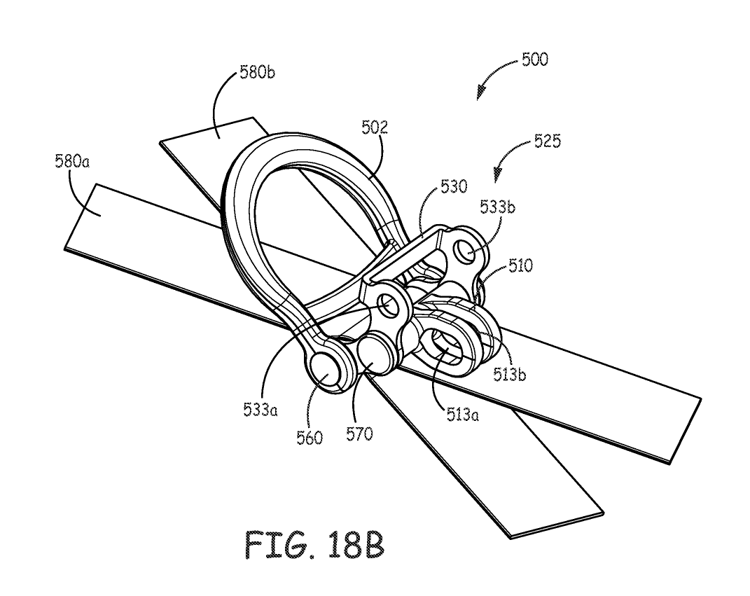

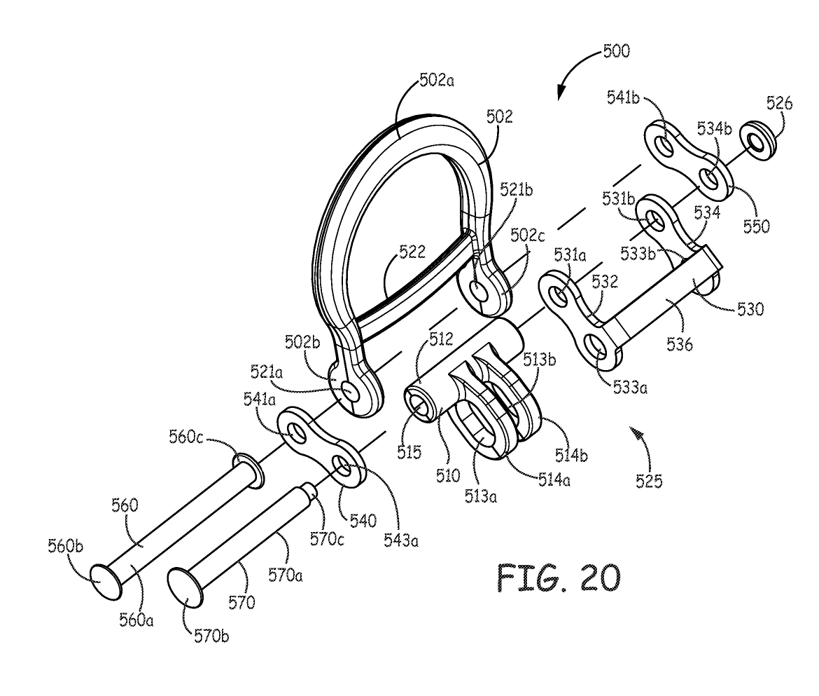

Another embodiment of a safety harness connection assembly 500 is illustrated in FIGS. 18A through 20. This embodiment includes a D-ring 502 and a device connector system 525. As illustrated in the exploded view in FIG. 20, the D-ring 502 is generally C shaped having a mid-portion 502a, a first end portion 502b and a second end portion 502c. A brace 522 extends across the D-ring 502 proximate the first end portion 502b and the second end portion 502c. Each of the first end portion 502b and the second end portion 502c includes a respective D-ring aperture 521a and 521b. The D-ring apertures 521a and 521b are aligned with each other.

The safety harness connector assembly 500 further includes a device connector system 525. The device connector system 525 includes a base member 510 and a connector member 530. The base member 510 includes a tubular portion 512 with a central base passage 515. From a surface of the tubular portion 512 extends first and second base arms 514a and 514b which, in this embodiment, are mirror images of each other. Moreover, in this embodiment, the first and second base arms 514a and 514b extend in a parallel fashion with each other from the surface of the tubular portion 512. The first base arm 514a includes a first base arm aperture 513a and the second base arm 514b includes a second base arm aperture 513b. The first base arm aperture 513a is aligned with the second base arm aperture 513b. The connector member 530 includes a first link 532 and a second link 534, The first link 532 is coupled to the second link 534 via connector bar portion 536 such that the first link 530 and the second link 534 are positioned parallel to each other while in a perpendicular fashion in relation to the connector bar portion 536. The first link 532 includes a first link first aperture 531a and a first link second aperture 533a. The second link 532 includes a second link first aperture 531b and a second link second aperture 533b. The first link first aperture 531a of the first link 532 is aligned with the second link first aperture 531b of the second link 534. Moreover, the first link second aperture 533a of the first link 532 is aligned with the second link second aperture 533b of the second link 534. In addition, the connector bar portion 536 is coupled to the first link 532 near the first link second aperture 533a and the second link 534 near the second link second aperture 533b.

The device connector system 525 further includes a third link 540 that includes a third link first aperture 541a and a third link second aperture 543a and a fourth link 550 that includes a fourth link first aperture 541a and a fourth link second aperture 543b. Also included in the device connector system 525 is a dorsal rivet 560 and a connector rivet 570. The dorsal rivet 560 includes a mid-shaft portion 560a that terminates in head ends 560b and 560c. The connector rivet 570 includes a mid-shaft portion 570a, a head end 570b and a terminal end 570c. The terminal end 570 is configured to receive a connecting nut 526. The mid-shaft portion 560a of the dorsal rivet 560 is received in the D-ring apertures 521a and 521b of the D-ring 502, the third link first aperture 541a of the third link 540 and the fourth link first aperture 541b of the fourth link 550 to pivotally couple the device connector system 525 to the D-ring 502. Further, the mid-shaft portion 570a of the connector rivet 570 is received in the third link second aperture 543a of the third link 540, the first link first aperture 531a of the first link 532, the central passage 515 of the base member 510, the second link first aperture 531b of the second link 534 and the fourth link second aperture 543b of the fourth link 550.

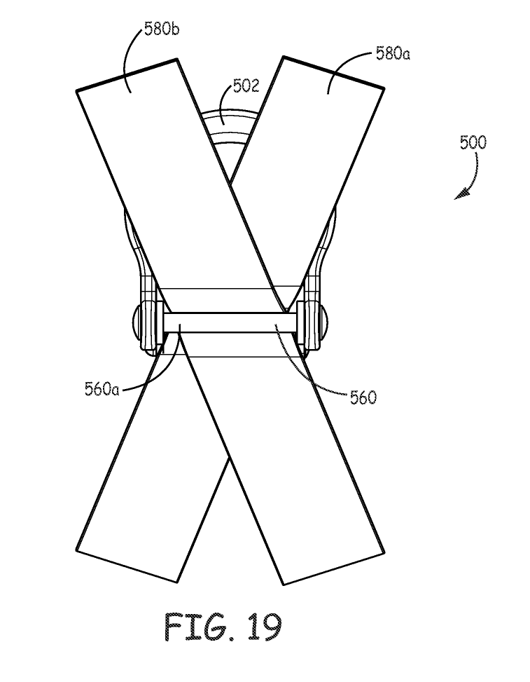

FIG. 18A illustrates the device connector system 525 in a first configuration. In this configuration, the first link second aperture 533a, the first base arm aperture 513a, the second base arm aperture 531b, and the second link second aperture 533b are all aligned to receive a connector that would be used to couple a device to the webbings 580a and 580b. In FIG. 18B, the connector member 530 is pivoted about connector rivet 570 so that the first link second aperture 533a and the second link second aperture 533b are no longer aligned with the first base arm aperture 513a and the second base arm aperture 513b. This configuration allows for a different type of connector to be used. FIG. 19 illustrates how the webbings 580a and 580b are routed around the mid-shaft portion 560a of the dorsal rivet 560 to couple the safety harness connector assembly 500 to the webbings 580a and 580b.

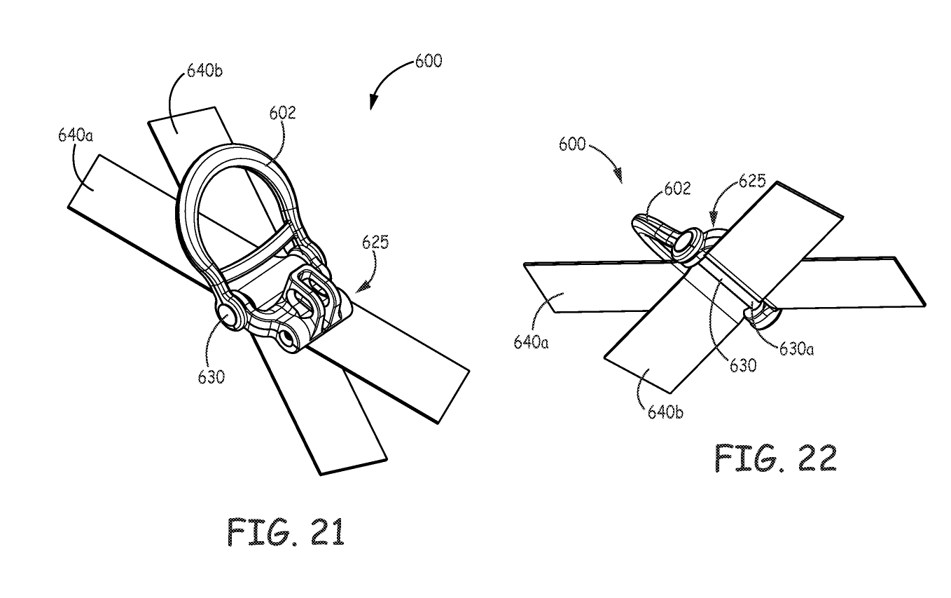

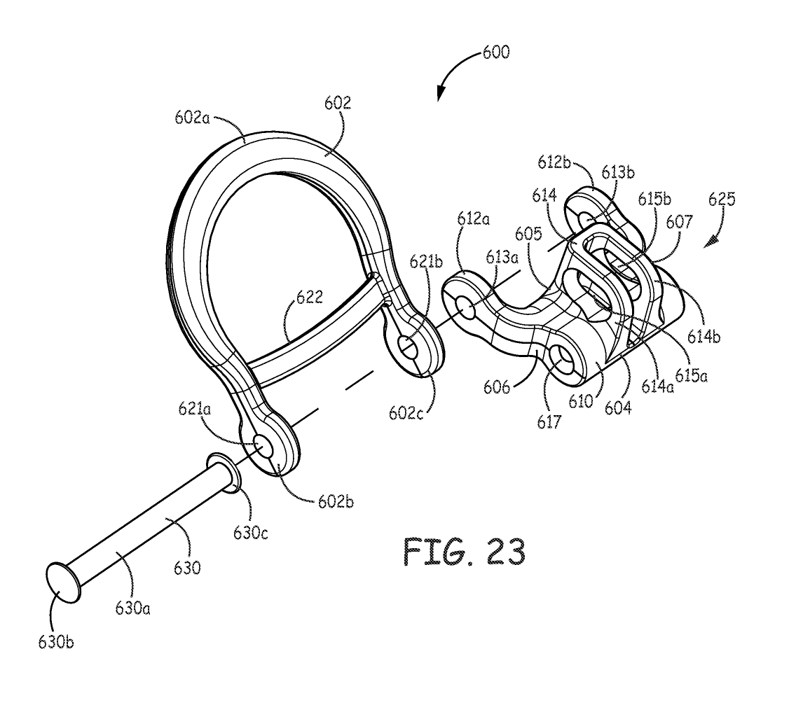

Referring to FIGS. 21 through 26C another safety harness connection assembly 600 embodiment is illustrated. In this embodiment, the safety harness connection assembly 600 includes a D-ring 602 and device connector system 625. Referring to FIG. 23, the D-ring 602 is generally C shaped having a mid-portion 602a, a first end portion 602b and a second end portion 602c. A brace 622 extends across the D-ring 602 proximate the first end portion 602b and the second end portion 602c. Each of the first end portion 602b and the second end portion 602c includes a respective D-ring aperture 621a and 621b. The D-ring apertures 621a and 621b are aligned with each other.

The device connector system 625 includes a base member 610 as best illustrated in FIG. 23. The base member 610 has a first edge 604 and an opposed second edge 605. The base member 610 further has a third edge 606 and an opposed fourth edge 607. A bore passage 617 extends through the base member 610 from the third edge 606 to the fourth edge 607. The bore passage 617 is positioned near the first edge 604 of the base member 610. Spaced first and second arms 612a and 612b extend out from the second edge 605 of the base member 610. The first arm 612a includes a first arm aperture 613a and the second arm 612b includes a second arm aperture 613b. The first arm aperture 613a and the second arm aperture 613b are aligned with each other. A generally U-shaped connection member 614 extends out from a surface of the base member 610 in a perpendicular fashion. An opening to the U-shape faces the first edge 604 of the base member 610. The connection member 614 includes a first wall 614a and a second wall 614b that are generally positioned parallel to each other. The first wall 614a includes a first wall aperture 615a and the second wall 614b includes a second wall aperture 615b. The first wall aperture 615a and the second wall aperture 615b are aligned. The device connector system further includes a dorsal rivet 630. The dorsal rivet 630 includes a mid-shaft portion 630a that terminates in head ends 630b and 630c. The arms 612a and 612b of the base member 610 are positioned between the end portions 602b and 602c of the D-ring 602. The mid-shaft portion 630a of the dorsal rivet 630 received in D-ring aperture 621a, first arm aperture 613a, second arm aperture 613b and D-ring aperture 621b pivotally couples the device connector system 625 to the D-Ring 602.

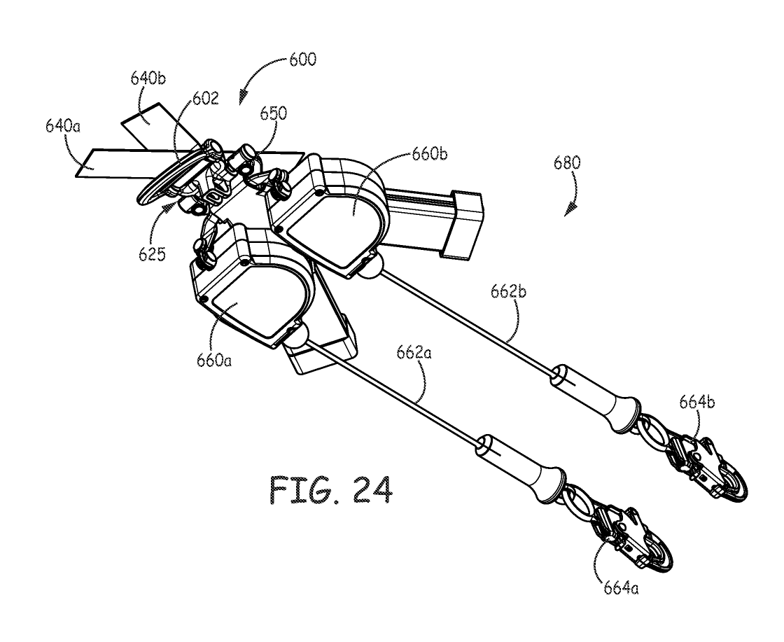

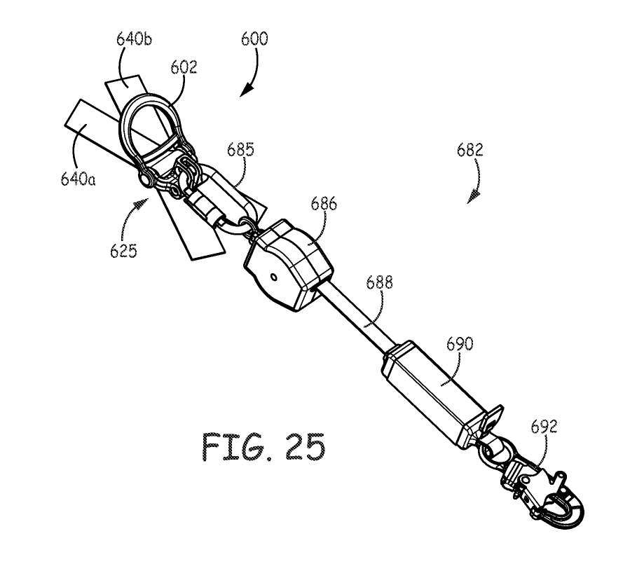

FIG. 21 illustrates the safety harness connection assembly 600 coupled to webbings 640a and 640b of a safety harness (not shown). FIG. 22 illustrates a back view of the safety harness connection assembly 600 coupled to webbings 640a and 640b. As illustrated, the webbings 640a and 640b are routed around the mid-shaft portion 630a of the dorsal rivet 630 to couple the safety harness connection assembly 600 to the webbings 640a and 640b. FIG. 24 illustrates the safety harness connection assembly 600 coupled to a SRL system 680 via SRL connector 650 being received in the bore passage 617 of the base member 610. The SRL system 680 in this example includes a pair of SRLs 660a and 660b, a pair of safety lines 662a and 662b and a pair of support structure connectors 664a and 664b. FIG. 25 illustrates the safety harness connection assembly 600 coupled to another SRL system 682 via carabiner 685 received in the first wall aperture 615a and the second wall aperture 615b of the base member 610. The SRL system in this embodiment includes a SRL 686, lifeline 688, energy absorber 690 and support structure connector 692.

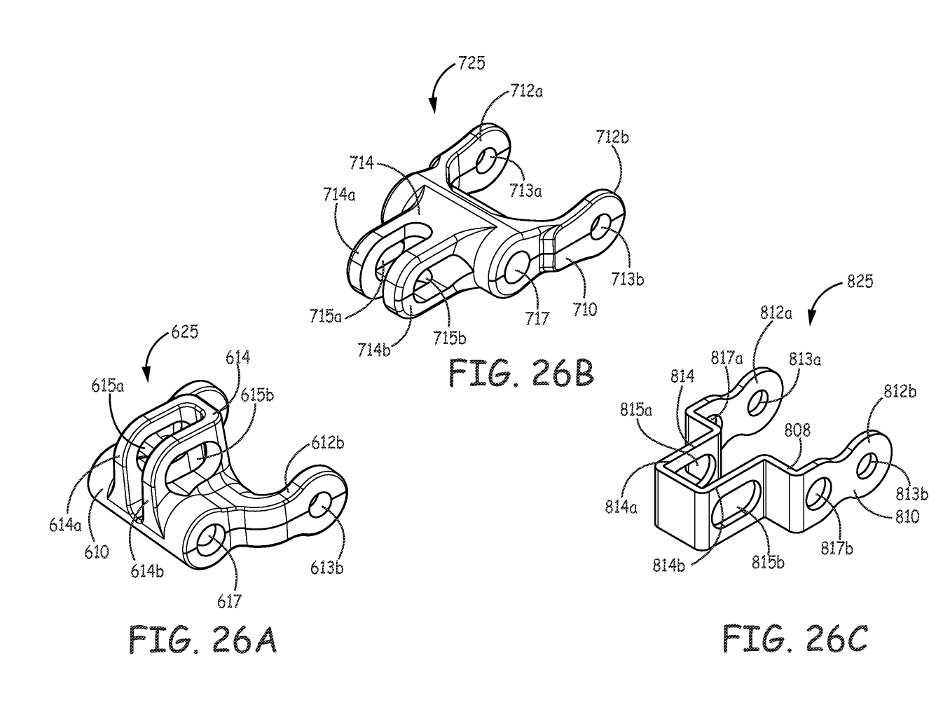

FIG. 26A illustrates the device connector system 625 as discussed above. FIG. 26B illustrates an alternative embodiment to the device connector system 625 that could be used in the safety harness connection assembly 600 described above. The device connector system 725 of FIG. 26B includes a base member 710. The base member 710 includes arms 712a and 712b and aligned arm passages 713a and 713b as well as a bore passage 717 similar to what is describe in relation to device connector system 625. Device connector system 725 differs in that the connection member 714 extends out from an edge of the base member 710 in an opposite direction from the arms 712a and 712b. The connection member 714 includes walls 714a and 714b that includes aligned wall passages 715a and 715b. Another example device connector system 825 is illustrated in FIG. 26C. In this example embodiment, the base member 810 is generally U-Shaped including a first arm 812a, a second arm 812b and a bridge portion 808. The bridge portion 808 is coupled between ends of the first arm 812a and second arm 812b. The first arm 812a includes a first arm passage 813a that is aligned with a second arm passage in the second arm 812b. The arms 812a and 812b includes respective aligned bore passages 817a and 817b. The aligned bore passages 817a and 817b are located near the bridge portion 808. Extending from a mid-portion of the bridge portion 808 is a connection portion 814. The connection portion 814 is also generally U-shaped having a first wall 814a and an opposed second wall 814b. The first wall 814a includes a first wall passage 815a and the second wall 814b includes a second wall passage 815b that is aligned with the first wall passage 815a. Hence, different interchangeable device connector systems 625, 725 and 825 can be used with the safety harness connection assembly 600.

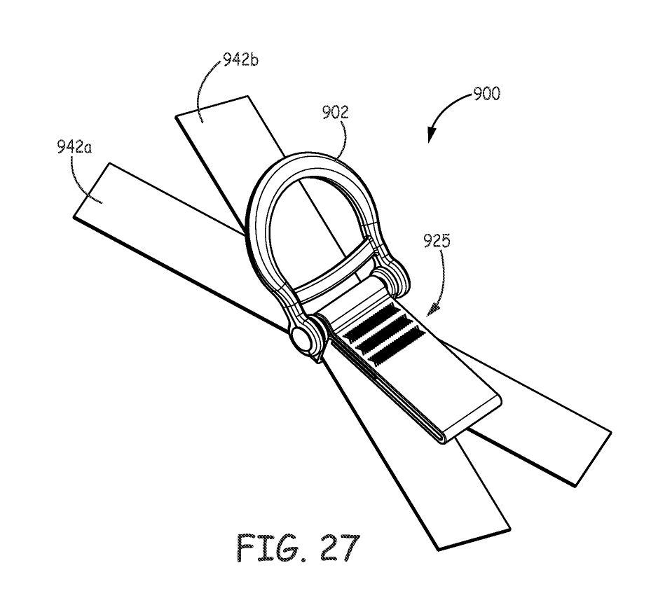

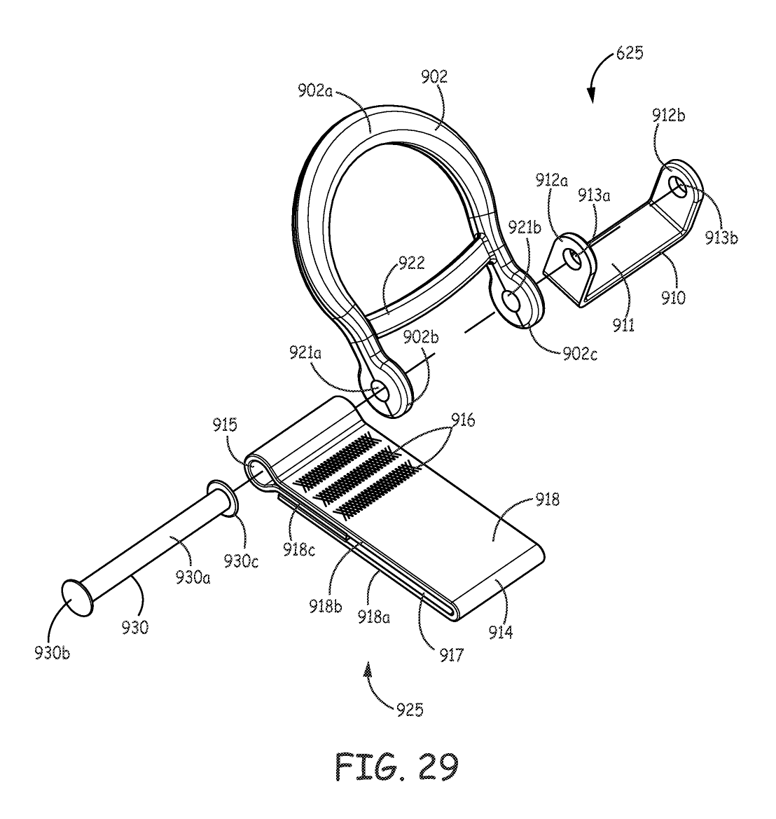

Referring to FIGS. 27 through 30, another embodiment of a safety harness connection assembly 900 is illustrated. This embodiment includes a D-ring 902 and a device connector system 925. As illustrated in the exploded view in FIG. 29, the D-ring 902 is generally C shaped having a mid-portion 902a, a first end portion 902b and a second end portion 902c. A brace 922 extends across the D-ring 902 proximate the first end portion 902b and the second end portion 902c. Each of the first end portion 902b and the second end portion 902c includes a respective D-ring aperture 921a and 921b. The D-ring apertures 921a and 921b are aligned with each other.

The safety harness connector assembly 900 further includes a device connector system 925 as best shown in FIG. 29. The device connector system 925 includes a base member 910 and a connector member 914. The base member 910 includes a base plate 911. First and second arms 912a and 912b extend perpendicularly from opposite ends of the base plate 911. The first arm 912a includes a first arm aperture 913a and the second arm 912b includes a second arm aperture 913b. The first arm aperture 913a is aligned with the second arm aperture 913b. The connector member 914 in one embodiment is made of a webbing 918 that is folded over on itself to form a dorsal aperture 915 at one end and a device connecting aperture 917 passage at the other end. In particular, the webbing 918 includes a first portion 918a upon which a second portion 918b is folded over. Further, a third portion 918c of the webbing (which is shorter than the first and second portions 918a and 918b is folded over and positioned between the first portion 918a and the second portion 918b. The first, second and third portions 918a, 918b and 918c are coupled together where all portions of the webbing overlap. In one embodiment, stitching is used to couple the portions 918a, 918b and 918c together although other methods such as, but not limit to, riveting can be used. The device connector system 925 also includes a dorsal rivet 930. The dorsal rivet 930 includes a mid-shaft portion 930a that terminates in head ends 930b and 930c. The base member 910 is positioned between the first end portion 902b and the second end portion 902c of the D-ring such that the first and second arm apertures 913a and 913b of the base plate 910 align with the D-ring apertures 921a and 921b of the D-ring 902. Further, a portion of the connector member 914 is positioned between the first and second arms 912a and 912b of the base member 910 such that the dorsal aperture 915 of the connector member 914 is aligned with the first arm aperture 913a and the second arm aperture 913b of the base member 910. The mid-shaft portion 930a of the dorsal rivet 930 is received in D-ring aperture 921a, the first arm aperture 913a, the dorsal'aperture 915, the second arm aperture 913b and D-ring aperture 921b to pivotally couple the device connector system 925 to the D-ring 902.

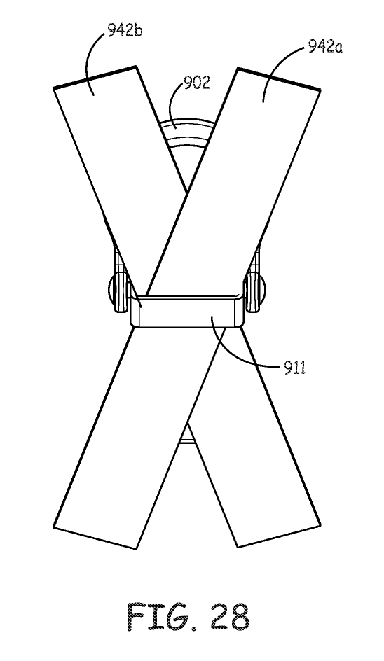

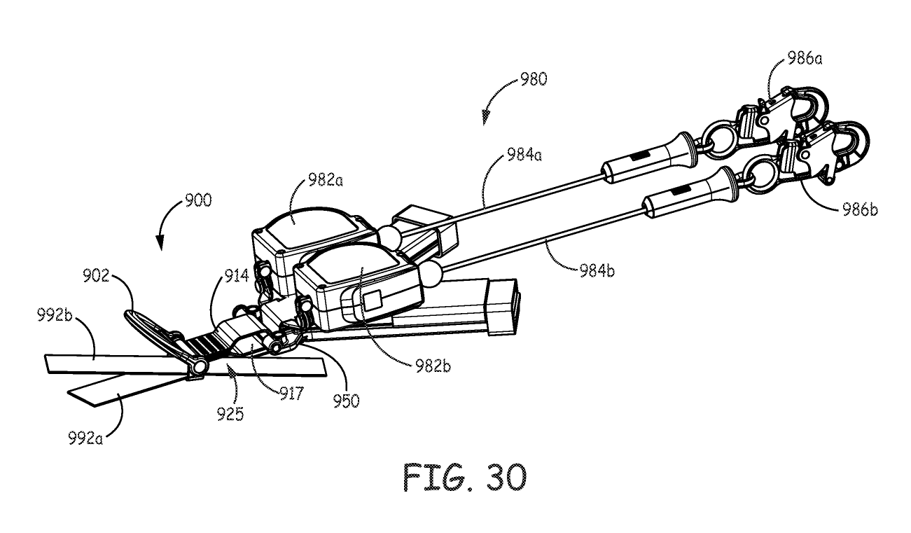

FIG. 27 illustrates the safety harness connection assembly 600 coupled to webbing 942a and 942b of a safety harness (not shown). FIG. 28 illustrates a back view of the safety harness connection assembly 900 coupled to the webbing 942a and 942b. As illustrated the webbings 942a and 942b are routed between the base plate 911 of the base member 910 and the dorsal rivet 930 (that is received in the dorsal aperture 915 of the connector member 914) to couple the webbings 942a and 942b to the safety harness connection assembly 900. Referring to FIG. 30, a SRL system 980 coupled to the safety harness connection assembly 900 is illustrated. As illustrated, a portion of a SRL connector 950 is received in the device connecting passage 917 of the connector member to couple the SRL system 980 to the safety harness connection assembly 900. The example SRL system 980 includes a pair of the SRLs 982a and 982b, a pair of lifelines 984a and 984b and a pair of support structure connectors 986a and 986b.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A safety harness connector assembly comprising:
a D-ring having generally a C-shape, the D-ring including a first end portion, a second end portion and mid-portion that extends between the first end portion and the second end portion, the first end portion having a first D-ring aperture and the second end portion having a second D-ring aperture, the first D-ring aperture being aligned with the second D-ring aperture;
a device connector system including at least one device connection aperture that is configured and arranged to couple a device to the safety harness connector assembly, the device connector system having at least one shaft connection aperture; and
a shaft received in the first and second D-ring apertures of the D-ring and in the at least one shaft connection aperture of the device connector system to pivotally couple the device connector system to the D-ring.

2. The safety harness connector assembly of claim 1, wherein the device connector system further comprises:
a base member, the base member including the at least one shaft connection aperture to pivotally couple the base member to the D-ring; and
at least one connector member, the at least one connector member further pivotally coupled to the D-ring, the at least one connection member including the at least one device connection aperture to couple the device to the safety harness connector assembly.

3. The safety harness connector assembly of claim 2, further comprising;
the base member having at least one base device connection aperture configured and arranged to couple the device to the safety harness connector assembly.

4. The safety harness connector assembly of claim 3, wherein the at least one base device connection aperture and the at least one device connection aperture selectively align in a select configuration of the device connector system.

5. The safety harness connector assembly of claim 1, wherein the device connector system further comprises:
a base member, the base member including the at least one shaft connection aperture to pivotally couple the base member to the D-ring;
a first connector member pivotally coupled to the base member, the first connector member having a first device connection passage;
a swivel connector pivotally coupled to the first connector member; and
a second connector member pivotally coupled to the swivel connector, the second connector member having a second device connection passage, the first device connection passage of the first connector member and the second device connection passage of the second connector member forming the at least one device connector aperture of the device connector system.

6. The safety harness connector assembly of claim 5, wherein the first connector member pivots on a first axis and the second connector member pivots on a second axis, the second axis being generally perpendicular to the first axis.

7. The safety harness connector assembly of claim 5, wherein the base member further comprises:
a first sidewall;
a second sidewall; and
a mid-plate portion coupled between the first sidewall and the second sidewall to form a tray to hold the device connector system.

8. The safety harness connector assembly of claim 7, wherein the base member has a webbing passage configured and arranged to allow webbing from a safety harness to be routed around the shaft to couple the safety harness connector assembly to the webbing of the safety harness.

9. The safety harness connector assembly of claim 5, wherein the base member further comprises:
a load attachment member configured and arranged to couple a load member of a safety harness to the base member of the safety harness connector assembly.

10. The safety harness connector assembly of claim 5, wherein the first connector member further comprises:
a first arm, the first arm having a first passage;
a second arm, the second arm having a second passage that is aligned with the first passage of the first arm, the first passage and the second passage receiving the shaft; and
a mounting rod, the first arm extending from a first end of the mounting rod and the second arm extending from a second end of the mounting arm, the mounting arm having the first device connection passage.

11. The safety harness connector assembly of claim 5, wherein the second connector member further comprises:
a first end portion;
a second end portion, the first end and second end portion pivotally coupled to the swivel connection; and
a generally C-shaped mid-portion forming the second device connection passage, the mid-portion of the second connector member further having a slot.

12. The safety harness connector assembly of claim 1, wherein the device connector system further comprises:
a base member having a stop plate that forms the at least one device connection aperture, the base member pivotally coupled to the shaft;
a gate pivotally coupled to the base member to selectively block access to the at least one device connection aperture formed by the stop plate of the base member; and
a lock member configured and arranged to lock the gate in a configuration that blocks access to the at least one connection aperture.

13. The safety harness connector assembly of claim 12, further comprising:
a gate biasing member configured and arranged to bias the gate to engage a portion of the stop plate of the base member; and
a lock biasing member configured and arranged to bias the lock member in a position to lock the gate.

14. The safety harness connector assembly of claim 1, wherein the device connector system further comprises:
at least one length of webbing.

15. The safety harness connector assembly of claim 14, further comprising:
the at least one length of webbing being folded over and coupled to itself to form the at least one shaft connection aperture and the at least one device connection aperture.

16. A safety harness connector assembly comprising:
a D-ring having generally a C-shape, the D-ring including a first end portion, a second end portion and mid-portion that extends between the first end portion and the second end portion, the first end portion having a first D-ring aperture and the second end portion having a second D-ring aperture, the first D-ring aperture being aligned with the second D-ring aperture;
a shaft received in the first and second D-ring aperture of the D-ring; and
a device connector system configured and arranged to couple devices to the safety harness connector assembly, the device connector system including,
a base member, the base member including at least one shaft connection aperture to receive the shaft to pivotally couple the base member to the D-ring,
a first connector member pivotally coupled to the base member, the first connector member having a first device connection passage,
a swivel connector pivotally coupled to the first connector member; and
a second connector member pivotally coupled to the swivel connector, the second connector member having a second device connection passage.

17. The safety harness connector assembly of claim 16, wherein the first connector member pivots on a first axis and the second connector member pivots on a second axis, the second axis being generally perpendicular to the first axis.

18. The safety harness connector assembly of claim 16, wherein the base member further comprises:
a first sidewall;
a second sidewall; and
a mid-plate portion coupled between the first sidewall and the second sidewall to form a tray to hold the device connector system, at least the first sidewall, the second sidewall and the mid-plate portion forming a webbing passage configured and arranged to allow webbing from a safety harness to be routed around the shaft to couple the safety harness connector assembly to the webbing of the safety harness.

19. A safety harness connector assembly comprising:
a device connector system configured and arranged to couple devices to the safety harness connector assembly, the device connector system including,
a base member pivotally coupled to at least one webbing of a safety harness;
a first connector member pivotally coupled to the base member, the first connector member having at least one first device connection passage,
a swivel connector pivotally coupled to the first connector member; and
a second connector member pivotally coupled to the swivel connector, the second connector member having at least one second device connection passage.

20. The safety harness connector assembly of claim 19, wherein the first connector member pivots on a first axis and the second connector member pivots on a second axis, the second axis being generally perpendicular to the first axis.

21. The safety harness connector assembly of claim 19, further comprising:
a D-ring having generally a C-shape, the D-ring including a first end portion, a second end portion and mid-portion that extends between the first end portion and the second end portion, the first end portion having a first D-ring aperture and the second end portion having a second D-ring aperture, the first D-ring aperture being aligned with the second D-ring aperture;
a shaft received in the first and second D-ring aperture of the D-ring; and
the base member including at least one shaft connection aperture to receive the shaft to pivotally couple the base member to the D-ring.
